(19) United States
(12) Patent Application Publication
(10) Pub. No.: US 2018/0274352 A1
(43) Pub. Date: Sep. 27, 2018

(54) SURFACE MANAGEMENT OF DRILL STRING ROTATION FOR STICK-AND-SLIP REDUCTION

(71) Applicant: Schlumberger Technology Corporation, Sugar Land, TX (US)

(72) Inventor: Jacques Orban, Katy, TX (US)

(21) Appl. No.: 15/465,111

(22) Filed: Mar. 21, 2017

(51) Int. Cl. E21B 44/04; E21B 3/02; G05B 19/042; H02J 3/46; H02J 3/34

(52) U.S. Cl. CPC E21B 44/04; E21B 3/02; E21B 47/12; H02J 3/46; H02J 3/34; G05B 19/042

(57) ABSTRACT

Systems and methods disclosed herein are directed to drilling rigs and, more specifically, to controlling the rotation of a drill string assembly to limit effects of irregular rotary movements form an AC induction motor driven by an inverter, associated with operation of a drilling rig. The systems and methods obtain rotational conditions of the rotary drilling system driven by a motor. Additionally, the systems and methods continuously generate, in response to a change in the rotational conditions, a supplied power to the motor at a frequency selected on relation of torque versus speed for the motor based on a virtual drive characteristic. The systems and methods can determine of the virtual drive characteristic to optimize coupling between the motor system and the rotational drilling system, as well as minimizing the effect of resonance and total noise.

### BACKGROUND

During subsurface drilling by a drilling rig, a drill string may experience various forces and torques as it rotates within a wellbore. The drill string may be rotated by a top drive or a kelly, and may include a drill pipe section, a bottom hole assembly, and other tools used to make a drill bit turn at the bottom of the wellbore. Torque is applied to sustain the rotation, as the drill bit may be in contact with the hole bottom to perform drilling, and friction may be present between the drill string and the wellbore. Due to the presence of torque along the drill string, the drill string may be twisted with a deformation angle that increases with depth. In addition, the inertia affects the rotation of the drill string during periods in which its speed of rotation changes.

“Stick-and-slip” refers to irregular rotational movement of a drill string due to the forces and torques caused by contact with elements surrounding a wellbore (e.g., a hole bottom, a liner, a casing, a wall of the wellbore, cuttings, etc.). Such contact may generate unsteady friction, which causes the drill string to slow and stick to one or more of the elements surrounding the wellbore. The friction depends of the relative velocity of the elements. Typically, the magnitude of the friction increases as the rotational velocity of the drill string decreases, and has its greatest effect when the drill string has substantially stopped. Sticking may also occur due to an element of the drill string locking with one of the elements surrounding the wellbore. For example, teeth of a drill bit teeth can lock in a hole-bottom due to high axial load (weight-on-bit or “WOB”), or stabilizer blades can stick in a discontinuity of the wellbore' s wall.

In response to situations such as those above, a motor driving the drill string may apply additional torque. Transmission of this additional torque, however, increases twisting of the drill string along its length, as it is an elastic system. This combination of increased torque and additional twisting stores potential energy in the drill string by elastic deformation. Thus, when the torque increase overcomes the friction or the locking effect generated by the bore wall and bottom, the potential energy is released as torque, which quickly accelerates the drill string in rotation. After the potential energy is expended, torque decreases and the drill string may slow and/or stop. Thus, over time, operation of the drill string can operate in pattern in which the drill string cyclically slows, stops, and quickly speeds up. As a result of this pattern, the drill string experiences a series of spikes in speed and torque, which can reduce its life span and the efficiency of the drilling operation.

### SUMMARY

Systems and methods disclosed herein are directed to drilling rigs and, more specifically, to controlling a drill string assembly to limit effects of irregular rotary movements associated with operation of a drilling rig. A system in accordance with aspects of the present disclosure includes a motor mechanically coupled to a rotary drilling system that drive the rotary drilling system. Additionally, the system includes a control system electrically coupled to the motor that dynamically generates a supply power for the motor in response to a change in rotational conditions of the rotary drilling system based on a virtual drive characteristic.

A method in accordance with the present disclosure controls rotary drilling system. The method includes obtaining rotational conditions of the rotary drilling system driven by a motor. The method also includes dynamically generating, in response to a change in the rotational conditions, a supply power of the motor at a frequency based on a virtual drive characteristic.

### BRIEF DESCRIPTION OF THE DRAWINGS

The accompanying drawings, which are incorporated in and constitute a part of this specification, illustrate implementations of the present disclosure and together with the description, serve to explain the principles of the present disclosure.

FIG. 1 illustrates a conceptual, schematic view of a control system for a drilling rig, according to an implementation.

FIG. 2 illustrates a conceptual, schematic view of a control system, according to an implementation.

FIG. 3 shows a functional block diagram illustrating an example of a top drive system and a rotary drilling system, according to an implementation.

FIG. 4 shows a flow diagram illustrating an example of a process for determining the optimized control of an induction motor rotating a rotary drilling system under variable well rotation conditions (e.g., stick-and-slip), according to an implementation.

FIG. 5 shows a graph illustrating an example of a reference function describing a virtual drive characteristic relating torque, speed, and drive frequency of a motor driving a drill string, according to an implementation.

FIG. 6 shows a graph of a reference function for a motor driving a drill string illustrating an example of selecting a nominal operating point for a motor, according to an implementation.

FIG. 7 shows a graph of a reference function for a motor driving a drill string illustrating an example of virtual drive characteristic at a nominal operating point of a motor, according to an implementation.

FIG. 8A shows a graph of reference function of a motor driving a drill string illustrating an example of a system output, according to an implementation.

FIG. 8B shows a graph of reference function for a motor driving a drill string illustrating an example of a system output, according to an implementation.

FIG. 9A shows a graph illustrating an example response of a drill string submitted to variable torque load along the wellbore, according to an implementation.

FIG. 9B shows a graph illustrating an example response of a motor driving a rotary drilling system, according to an implementation.

FIG. 9C shows a graph illustrating an example of a rotary drive system of a rotary drilling system, according to an implementation.

FIG. 10A shows a graph illustrating an example of a system response as typically detected at surface, according to an implementation.

FIG. 10B shows a graph illustrating an example of a drilling system response, according to an implementation.

FIG. 10C shows a graph illustrating an example of a drilling system response as processed information after operations at multiple operating conditions, according to an implementation.

FIG. 10D shows a graph illustrating an example of a drilling system response within the wellbore, according to an implementation.

FIG. 11A illustrates a flow diagram of a process for determining a virtual drive characteristic for a motor combined with drive electronics actuating a rotary drilling system, according to an implementation.

FIG. 11B illustrates a flow diagram of a process for determining a virtual drive characteristic for a motor combined with drive electronics actuating a rotary drilling system, according to an implementation.

FIG. 11C illustrates a flow diagram of a process for determining a virtual drive characteristic for a motor combined with drive electronics actuating a rotary drilling system, according to an implementation.

FIG. 12 shows a block diagram illustrating an example of a rotary drilling system, according to an implementation.

FIG. 13A illustrates a flow diagram of a process determining a virtual motor inertia for a motor combined with drive electronics actuating a rotary drilling system, according to an implementation.

FIG. 13B illustrates a flow diagram of a process determining a virtual motor inertia for a motor combined with drive electronics actuating a rotary drilling system, according to an implementation.

FIG. 13C illustrates a flow diagram of a process determining a virtual motor inertia for a motor combined with drive electronics actuating a rotary drilling system, according to an implementation.

FIG. 13D illustrates a flow diagram of a process determining a virtual motor inertia for a motor combined with drive electronics actuating a rotary drilling system, according to an implementation.

FIG. 14 shows a graph illustrating a graph of the reference function for a motor driving a drill string, according to an implementation.

FIG. 15 shows a graph illustrating an example of a response for a controlled motor versus different excitation frequencies of the rotary drilling system, according to an implementation.

FIG. 16 shows a graph illustrating an example of a response for a controlled motor versus different “adjustment-rate” under a steady excitation frequency of the rotary drilling system, according to an implementation.

FIG. 17A shows a graph illustrating an example of the mapping of the coherent noise due to distortion of the driving process of a rotary drilling system operating under variable rotational conditions of a well, according to an implementation.

FIG. 17B shows a graph illustrating an example of the mapping of the random noise generated during the operation of the rotary drilling system, according to an implementation.

FIG. 17C shows a graph illustrating an example of the mapping of the total noise generated during the operation of the rotary drilling system, according to an implementation.

FIG. 17D shows a graph illustrating some examples of total noise during operation of the rotary drilling system at different conditions, according to an implementation.

FIG. 18A shows a flow diagram illustrating a process for determining an adjustment rate for drive electronics of a motor actuating a rotary drilling system, according to an implementation.

FIG. 18B shows a flow diagram illustrating a process for determining an adjustment rate for drive electronics of a motor actuating a rotary drilling system, according to an implementation.

FIG. 18C shows a flow diagram illustrating a process for determining an adjustment rate, according to an implementation.

FIG. 19 illustrates one method to estimate the coherent noise due to distortion of the rotary process, according to an implementation.

FIG. 20 shows a graph illustrating a reference function of a motor combined with drive electronics actuating a rotary drilling system, according to an implementation.

FIG. 21 shows block diagram of an example of an information processing system, according to an implementation.

### DETAILED DESCRIPTION

Systems and methods disclosed herein are directed to controlling a drill string assembly to limit effects of irregular rotary movements associated with operation of a drilling rig. More specifically, implementations of the systems and methods can control torque and speed variations of a drill string assembly driven by an alternating current (AC) induction motor and a variable frequency drive (VFD) to limit the effect of the variable friction on drill string assembly while operating in a wellbore.

In accordance with aspects of the systems and methods disclosed herein, rotational parameters of the drill string assembly and parameters of a motor driving the drill string are measured to control the VFD and its associated motor so as to minimize the effects of variable friction on the drill string (e.g., stick-and-slip) such as torque changes and/or twisting of the drill string in a wellbore. Implementations disclosed herein minimize the effects of such variable friction by actively controlling a frequency of AC power output by the VFD based on a “virtual drive characteristic” (“VDC”) between torque and speed of the motor. By controlling of the frequency of the AC power output to the motor based on the virtual drive characteristic, the motor outputs a torque that varies smoothly in opposite way of the smooth variation of speed in response to rotational conditions along the wellbore, rather than producing sharp torque variations and low variation of speed that may otherwise occur for the similar variation of rotational conditions along the wellbore.

The VDC includes a predetermined system response defining a relationship between a target torque and speed at or around a selected operating point. The virtual drive characteristic can be a substantially linear profile with a slope (α) and represents the relationship between torque and speed of a motor. Implementations consistent with those disclosed herein use the virtual drive characteristic to control the motor to operate with a substantially constant output power, such that the speed at which the drill string assembly is driven decreases substantially as torque increases. For example, implementations minimize changes in torque on the drill string due to change in well rotational conditions (e.g., stick-and-slip) by dynamically controlling the speed and torque output of the motor. By doing so, the disclosed systems and methods can modify the effective impedance coupling between the motor and the drill string assembly to insure a smooth power transfer to the drill-string while operating in presence of variation of well-rotational conditions (e.g., stick-and-slip). This smooth power transfer would reduce the abrupt change of torque at the top drive and reduce the fatigue of the drill-string and top drive.

Additionally, systems and methods consistent with those disclosed herein can determine and use a virtual motor rotor inertia (βv) (e.g., a virtual flywheel) to improve the rotation of a rotary drilling system which includes the drill-string, the bottom-hole assembly (“BHA”).and the rotating part of the top-drive (e.g., the motor rotor). Such improvement can modify a resonance frequency of the rotary drilling system to insure that the resonance frequencies of the rotary drilling system do not match the frequencies of the source of excitation by variation of well-rotational conditions (such as change of friction along the wellbore or stick-slip frequency). Further, systems and methods consistent with those disclosed herein can improve the rotation of the drill string by determining and using an adjustment rate (X) for dynamically adjusting the frequency of the output power provided to the motor, allowing a minimization of the total noise generated within the drive system associated with the rotary drilling system.

Reference will now be made in detail to specific implementations illustrated in the accompanying drawings and figures. In the following detailed description, numerous specific details are set forth in order to provide a thorough understanding of disclosed implementations. However, it will be apparent to one of ordinary skill in the art that implementations may be practiced without these specific details. In other instances, well-known methods, procedures, components, circuits, and networks have not been described in detail so as not to unnecessarily obscure aspects of the implementations. It will also be understood that, although the terms first, second, etc. may be used herein to describe various elements, these elements should not be limited by these terms. These terms are only used to distinguish one element from another. For example, a first object could be termed a second object or step, and, similarly, a second object could be termed a first object or step, without departing from the scope of the present disclosure.

The terminology used in the description is for the purpose of describing particular implementations only and is not intended to be limiting. As used in the description and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

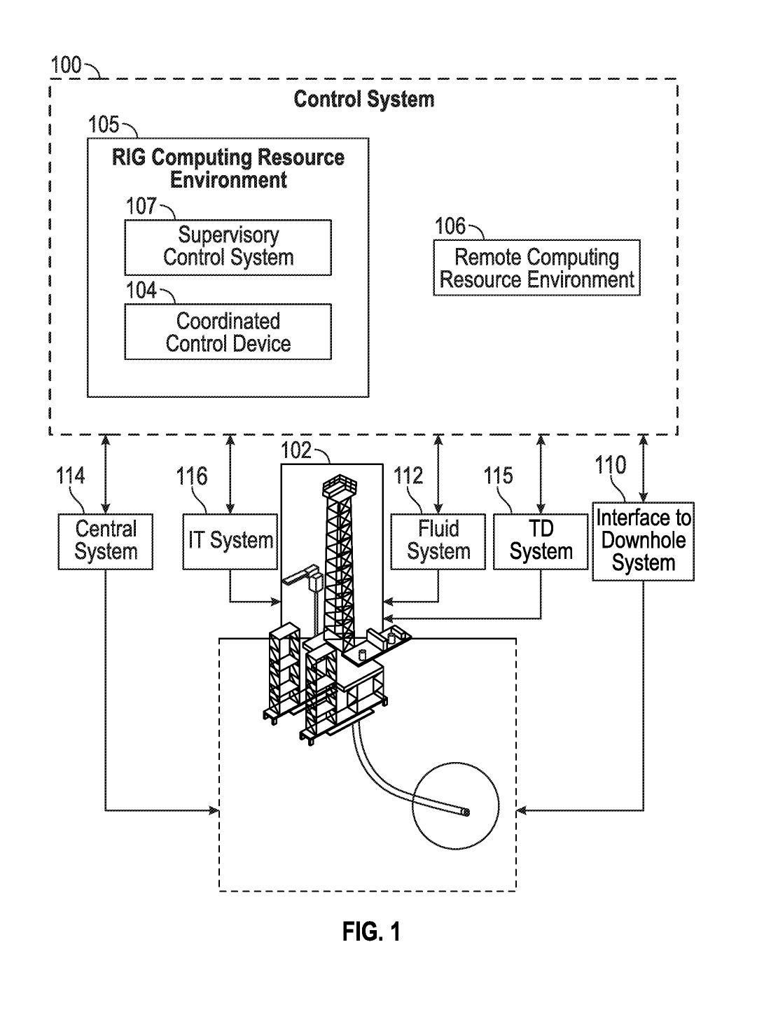

FIG. 1 illustrates a conceptual, schematic view of a control system 100 for a drilling rig 102, according to an implementation. The control system 100 may include a rig computing resource environment 105, which may be located onsite at the drilling rig 102 and, in some implementations, may have a coordinated control device 104. The control system 100 may also provide a supervisory control system 107. In some implementations, the control system 100 may include a remote computing resource environment 106, which may be located offsite from the drilling rig 102.

The remote computing resource environment 106 may include computing resources locating offsite from the drilling rig 102 and accessible over a network. A “cloud” computing environment is one example of a remote computing resource. The cloud computing environment may communicate with the rig computing resource environment 105 via a network connection (e.g., a WAN or LAN connection). In some implementations, the remote computing resource environment 106 may be at least partially located onsite, e.g., allowing control of various aspects of the drilling rig 102 onsite through the remote computing resource environment 105 (e.g., via mobile devices). Accordingly, “remote” should not be limited to any particular distance away from the drilling rig 102.

Further, the drilling rig 102 may include various systems with different sensors and equipment for performing operations of the drilling rig 102, and may be monitored and controlled via the control system 100, e.g., the rig computing resource environment 105. Additionally, the rig computing resource environment 105 may provide for secured access to rig data to facilitate onsite and offsite user devices monitoring the rig, sending control processes to the rig, and the like.

Various example systems of the drilling rig 102 are depicted in FIG. 1. For example, the drilling rig 102 may equipped with an interface to a downhole system 110, a fluid system 112, a central system 114, and top drive (“TD”) system 115. These systems 110, 112, 114, and 115 may also be examples of “subsystems” of the drilling rig 102, as described herein. In some implementations, the drilling rig 102 may also include an information technology (IT) system 116.

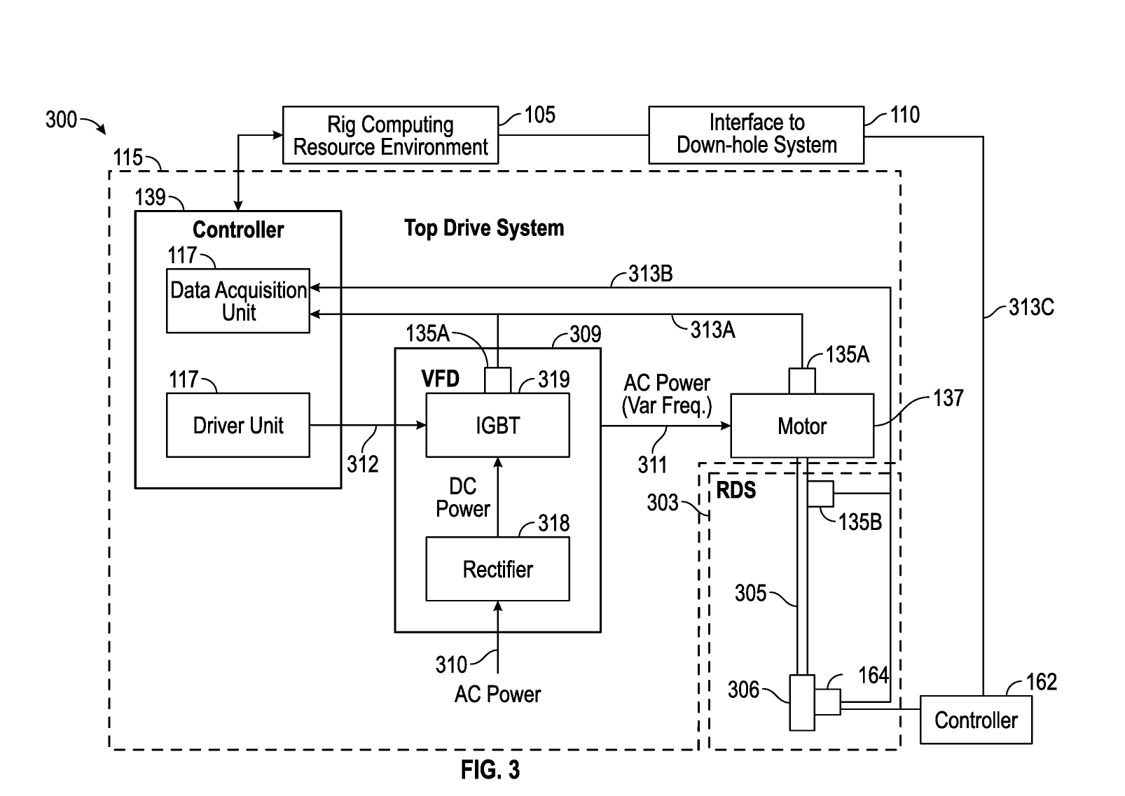

A downhole system may include, for example, a bottom hole assembly (BHA), mud motors, sensors, etc. disposed along the drill string, and/or other drilling equipment configured to be deployed into the wellbore. (See, e.g., FIG. 3.) Accordingly, the downhole system may refer to tools disposed in the wellbore, e.g., as part of the drill string used to drill the well. The interface to the downhole system 110 may include one or devices that communicate with a downhole system (not shown) to send and/or received information to and/or from the downhole system.

The fluid system 112 may include, for example, drilling mud, pumps, valves, cement, mud-loading equipment, mud-management equipment, pressure-management equipment, separators, and other fluids equipment. Accordingly, the fluid system 112 may perform fluid operations of the drilling rig 102.

The central system 114 may include a hoisting and rotating platform, rotary tables, kellys, drawworks, pumps, generators, tubular handling equipment, derricks, masts, substructures, and other suitable equipment. Accordingly, the central system 114 may perform power generation, hoisting, and rotating operations of the drilling rig 102, and serve as a support platform for drilling equipment and staging ground for rig operation, such as connection make up, etc.

The top drive system 115 can be a system that rotates a drill string assembly. The top drive system 115 can include, a motor connected with appropriate gearing to a short section of pipe (a.k.a., “a quill”) that in turn may be mechanically linked to a saver sub or the drill string itself. Additionally, the top drive system 115 can include control system that, among other functions, can control the motor to minimize stick and slip of the drill string in accordance with aspects of the present disclosure. In implementations, the top drive system 115 can be a subsystem of the central system 114 that performs the rotating operations of the drilling rig 102.

The IT system 116 may include software, computers, and other IT equipment for implementing IT operations of the drilling rig 102. In implementations, some or all of the components and/or functions of the top drive system 115 implemented within components of the central system 114 and/or the IT system.

The control system 100, e.g., via the coordinated control device 104 of the rig computing resource environment 105, may monitor sensors from multiple systems of the drilling rig 102 and provide control commands to multiple systems of the drilling rig 102, such that sensor data from multiple systems may be used to provide control commands to the different systems of the drilling rig 102. For example, the control system 100 may collect temporally and depth aligned surface data and downhole data from the drilling rig 102 and store the collected data for access onsite at the drilling rig 102 or offsite via the rig computing resource environment 105. Thus, the control system 100 may provide monitoring capability. Additionally, the control system 100 may include supervisory control via the supervisory control system 107.

In some implementations, one or more of the interface to the interface to the downhole system 110, fluid system 112, central system 114, and the top drive system 115 may be manufactured and/or operated by different vendors. In such an implementation, certain systems may not be capable of unified control (e.g., due to different protocols, restrictions on control permissions, safety concerns for different control systems, etc.). An implementation of the control system 100 that is unified, may, however, provide control over the drilling rig 102 and its related systems (e.g., the interface to the downhole system 110, fluid system 112, and/or central system 114, etc.). Likewise, the fluid system 112, the central system 114, and the top drive system 115 may contain one or a plurality of fluid systems, central systems, and top drive systems, respectively.

In addition, the coordinated control device 104 may interact with the onsite or offsite user device(s) (e.g., human-machine interface(s) 118, 120). For example, the coordinated control device 104 may receive commands from the user devices and may execute the commands using two or more of the systems 110, 112, 114, and 115, e.g., such that the operation of the two or more systems 110, 112, 114, and 115 act in concert and/or off-design conditions in the systems 110, 112, 114, and 115 may be avoided.

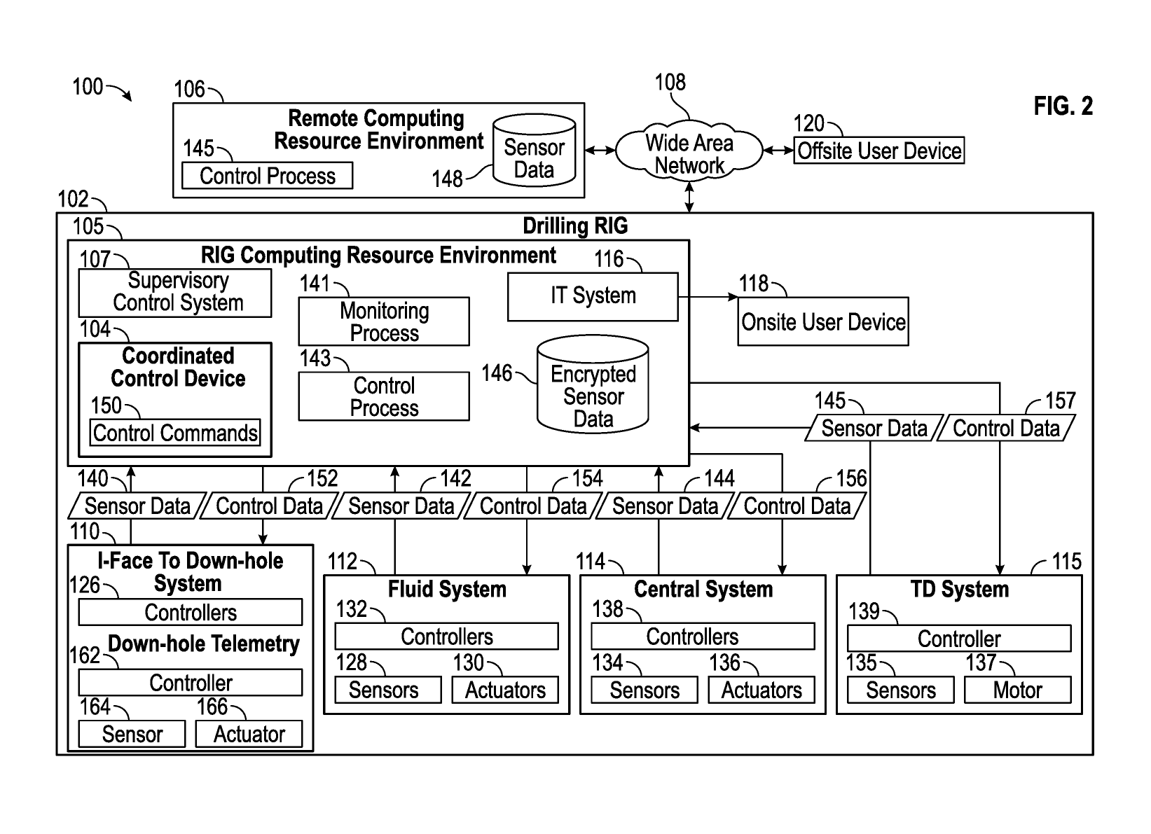

FIG. 2 illustrates a conceptual, schematic view of the aforementioned control system 100, according to an implementation. The rig computing resource environment 105 of the control system 100 may communicate with offsite devices, such as offsite user devices 120 using a network 108 (e.g., a wide area network (WAN) such as the internet). Further, the rig computing resource environment 105 may communicate with the remote computing resource environment 106 via the network 108.

FIG. 2 also depicts the aforementioned example systems of the drilling rig 102, such as the interface to the downhole system 110, the fluid system 112, the central system 114, the top drive system 115, and the IT system 116. In some implementations, one or more onsite user devices 118 may also be included on the drilling rig 102. The onsite user devices 118 may interact with the IT system 116. The onsite user devices 118 may include any number of user devices, for example, stationary user devices intended to be stationed at the drilling rig 102 and/or portable user devices. In some implementations, the onsite user devices 118 may include a desktop, a laptop, a smartphone, a personal data assistant (PDA), a tablet component, a wearable computer, or other suitable devices. In some implementations, the onsite user devices 118 may communicate with the rig computing resource environment 105 of the drilling rig 102, the remote computing resource environment 106, or both.

One or more offsite user devices 120 may also be included in the system 100. The offsite user devices 120 may include a desktop, a laptop, a smartphone, a personal data assistant (PDA), a tablet component, a wearable computer, or other suitable devices. The offsite user devices 120 may be configured to receive and/or transmit information (e.g., monitoring functionality) from and/or to the drilling rig 102 via communication with the rig computing resource environment 105. In some implementations, the offsite user devices 120 may provide control processes for controlling operation of the various systems of the drilling rig 102. In some implementations, the offsite user devices 120 may communicate with the remote computing resource environment 106 via the network 108.

The user devices 118 and/or 120 may be examples of a human-machine interface. These devices 118, 120 may allow feedback from the various rig subsystems to be displayed and allow commands to be entered by the user. In various implementations, such human-machine interfaces may be onsite or offsite, or both.

The systems of the drilling rig 102 may include various sensors, motors, and controllers (e.g., programmable logic controllers (PLCs)), which may provide feedback for use in the rig computing resource environment 105. The fluid system 112 may include sensors 128, actuators 130, and controllers 132. Additionally, the central system 114 may include sensors 134, actuators 136, and controllers 138. Further, the top drive system 115 can include sensors 135, motor 137, and controller 139.

The interface to downhole system 110 allows information exchange with the downhole system of the rig. The interface to the downhole system 110 can include In implementations, the controllers 126 communicates with a downhole controller 162 that communicates with an up-hole controller via down-hole telemetry. The down-hole telemetry may be wireless such as MWD mud-pulse or E MAG telemetry or cable base communication or wire-drill-pipe telemetry system. This allows the interface to the downhole system 110 to access devices remotely located in the downhole system (e.g., sensors, actuators, motors, and downhole controller).

The sensors 164, 128, 134, and 135, as well as the sensors located in the downhole system (not shown), may include any suitable sensors for operation of the drilling rig 102 and drilling operations. In some implementations, such sensors may include a camera, a speed sensor (measuring, e.g., revolutions per second), a torque sensor (e.g., of motor 137), a pressure sensor, a temperature sensor, a flow rate sensor, a vibration sensor, a current sensor, a voltage sensor, a resistance sensor, a gesture detection sensor or device, a voice actuated or recognition device or sensor, or other suitable sensors.

The sensors described above may provide sensor data feedback to the rig computing resource environment 105 (e.g., to the coordinated control device 104). For example, downhole system sensors 164 and sensors located in the downhole system (not shown) may provide sensor data 140, the fluid system sensors 128 may provide sensor data 142, the top drive sensors 135 may provide sensor data 145, and the central system sensors 128 may provide sensor data 144. The sensor data 164, 140, 142, 144, and 145 may include, for example, equipment operation status (e.g., on or off, up or down, set or release, etc.), drilling parameters (e.g., depth, hook load, torque, etc.), auxiliary parameters (e.g., vibration data of a pump) and other suitable data. In some implementations, the acquired sensor data may include or be associated with a timestamp (e.g., a date, time or both) indicating when the sensor data was acquired. Further, the sensor data may be aligned with a depth or other drilling parameter.

Acquiring the sensor data into the coordinated control device 104 may facilitate measurement of the same physical properties at different locations of the drilling rig 102 and downhole system 160. In some implementations, measurement of the same physical properties may be used for measurement redundancy to enable continued operation of the well. In yet another implementation, measurements of the same physical properties at different locations may be used for detecting equipment conditions among different physical locations. In yet another implementation, measurements of the same physical properties using different sensors may provide information about the relative quality of each measurement, resulting in a “higher” quality measurement being used for rig control, and process applications. The variation in measurements at different locations over time may be used to determine equipment performance, system performance, scheduled maintenance due dates, and the like. Furthermore, aggregating sensor data from each subsystem into a centralized environment may enhance drilling process and efficiency. For example, slip status (e.g., in or out) may be acquired from the sensors and provided to the rig computing resource environment 105, which may be used to define a rig state for automated control. In another example, acquisition of fluid samples may be measured by a sensor and related with bit depth and time measured by other sensors. Acquisition of data from a camera sensor may facilitate detection of arrival and/or installation of materials or equipment in the drilling rig 102. The time of arrival and/or installation of materials or equipment may be used to evaluate degradation of a material, scheduled maintenance of equipment, and other evaluations.

The coordinated control device 104 may facilitate control of individual systems (e.g., the interface to the downhole system 110, the central system 114, the downhole system (not shown), or fluid system 112, etc.) at the level of each individual system. For example, in the fluid system 112, sensor data 128 may be fed into the controller 132, which may respond to control the actuators 130. However, for control operations that involve multiple systems, the control may be coordinated through the coordinated control device 104. Examples of such coordinated control operations include the control of downhole pressure during tripping. The downhole pressure may be affected by both the fluid system 112 (e.g., pump rate and choke position) and the central system 114 (e.g., tripping speed). When it is desired to maintain certain downhole pressure during tripping, the coordinated control device 104 may be used to direct the appropriate control commands. Furthermore, for mode based controllers which employ complex computation to reach a control set point, which are typically not implemented in the subsystem PLC controllers due to complexity and high computing power demands, the coordinated control device 104 may provide the adequate computing environment for implementing these controllers.

In some implementations, control of the various systems of the drilling rig 102 may be provided via a multi-tier (e.g., three-tier) control system that includes a first tier of the controllers 126, 132, 138, and 139, a second tier of the coordinated control device 104, and a third tier of the supervisory control (e.g., supervisory control system 107). The first tier of the controllers may be responsible for safety critical control operation, or fast loop feedback control. The second tier of the controllers may be responsible for coordinated controls of multiple equipment or subsystems, and/or responsible for complex model based controllers. The third tier of the controllers may be responsible for high level task planning, such as to command the rig system to maintain certain bottom hole pressure. In other implementations, coordinated control may be provided by one or more controllers of one or more of the drilling rig systems 110, 112, 114, and 115 without the use of a coordinated control device 104. In such implementations, the rig computing resource environment 105 may provide control processes directly to these controllers for coordinated control. For example, in some implementations, the controllers 126, 132, 138, and/or 139 may be used for coordinated control of multiple systems of the drilling rig 102.

The sensor data 140, 142, 144, and 145 may be received by the coordinated control device 104 and used for control of the drilling rig 102 and the drilling rig systems 110, 112, 114, and 115. In some implementations, the sensor data 140, 142, 144, and 145 may be encrypted to produce encrypted sensor data 146. For example, in some implementations, the rig computing resource environment 105 may encrypt sensor data from different types of sensors and systems to produce a set of encrypted sensor data 146. Thus, the encrypted sensor data 146 may not be viewable by unauthorized user devices (either offsite or onsite user device) if such devices gain access to one or more networks of the drilling rig 102. The sensor data 140, 142, 144, and 145 may include a timestamp and an aligned drilling parameter (e.g., depth) as discussed above. The encrypted sensor data 146 may be sent to the remote computing resource environment 106 via the network 108 and stored as encrypted sensor data 148.

The rig computing resource environment 105 may provide the encrypted sensor data 148 available for viewing and processing offsite, such as via offsite user devices 120. Access to the encrypted sensor data 148 may be restricted via access control implemented in the rig computing resource environment 105. In some implementations, the encrypted sensor data 148 may be provided in real-time to offsite user devices 120 such that offsite personnel may view real-time status of the drilling rig 102 and provide feedback based on the real-time sensor data. For example, different portions of the encrypted sensor data 146 may be sent to offsite user devices 120. In some implementations, encrypted sensor data may be decrypted by the rig computing resource environment 105 before transmission or decrypted on an offsite user device after encrypted sensor data is received.

The offsite user device 120 may include a client (e.g., a thin client) configured to display data received from the rig computing resource environment 105 and/or the remote computing resource environment 106. For example, multiple types of thin clients (e.g., devices with display capability and minimal processing capability) may be used for certain functions or for viewing various sensor data.

The rig computing resource environment 105 may include various computing resources used for monitoring and controlling operations such as one or more computers having a processor and a memory. For example, the coordinated control device 104 may include a computer having a processor and memory for processing sensor data, storing sensor data, and issuing control commands responsive to sensor data. As noted above, the coordinated control device 104 may control various operations of the various systems of the drilling rig 102 via analysis of sensor data from one or more drilling rig systems (e.g., 110, 112, 114, and 115) to enable coordinated control between each system of the drilling rig 102. The coordinated control device 104 may execute control commands 150 for control of the various systems of the drilling rig 102 (e.g., 110, 112, 114, and 115). The coordinated control device 104 may send control data determined by the execution of the control commands 150 to one or more systems of the drilling rig 102. For example, control data 152 may be sent to the interface to the downhole system 110, control data 154 may be sent to the fluid system 112, control data 157 may be sent to the top drive system 115, and control data 156 may be sent to the central system 114. The control data may include, for example, operator commands (e.g., turn on or off a pump, switch on or off a valve, update a physical property set point, etc.). In some implementations, the coordinated control device 104 may include a fast control loop that directly obtains sensor data 140, 142, 144, and 145 may and executes, for example, a control algorithm. In some implementations, the coordinated control device 104 may include a slow control loop that obtains data via the rig computing resource environment 105 to generate control commands.

In some implementations, the coordinated control device 104 may intermediate between the supervisory control system 107 and the controllers 126, 132, 138, and 139 of the systems 110, 112, 114, and 115. For example, in such implementations, a supervisory control system 107 may be used to control systems of the drilling rig 102. The supervisory control system 107 may include, for example, devices for entering control commands to perform operations of systems of the drilling rig 102. In some implementations, the coordinated control device 104 may receive commands from the supervisory control system 107, process the commands according to a rule (e.g., an algorithm based upon the laws of physics for drilling operations), and/or control processes received from the rig computing resource environment 105, and provides control data to one or more systems of the drilling rig 102. In some implementations, the supervisory control system 107 may be provided by and/or controlled by a third party. In such implementations, the coordinated control device 104 may coordinate control between discrete supervisory control systems and the systems 110, 112, 114, and 115 while using control commands that may be improved from the sensor data received from the systems 110 112, 114, and 115 and analyzed via the rig computing resource environment 105.

The rig computing resource environment 105 may include a monitoring process 141 that may use sensor data to determine information about the drilling rig 102. For example, in some implementations the monitoring process 141 may determine a drilling state, equipment health, system health, a maintenance schedule, or any combination thereof. Furthermore, the monitoring process 141 may monitor sensor data and determine the quality of one or a plurality of sensor data. In some implementations, the rig computing resource environment 105 may include control processes 143 that may use the sensor data 146 to improve drilling operations, such as, for example, the control of drilling equipment to improve drilling efficiency, equipment reliability, and the like. For example, in some implementations the acquired sensor data may be used to derive a noise cancellation scheme to improve electromagnetic and mud pulse telemetry signal processing. The control processes 143 may be implemented via, for example, a control algorithm, a computer program, firmware, or other suitable hardware and/or software. In some implementations, the remote computing resource environment 106 may include a control process 143 that may be provided to the rig computing resource environment 105.

The rig computing resource environment 105 may include various computing resources, such as, for example, a single computer or multiple computers. In some implementations, the rig computing resource environment 105 may include a virtual computer system and a virtual database or other virtual structure for collected data. The virtual computer system and virtual database may include one or more resource interfaces (e.g., web interfaces) that enable the submission of application programming interface (API) calls to the various resources through a request. In addition, each of the resources may include one or more resource interfaces that enable the resources to access each other (e.g., to enable a virtual computer system of the computing resource environment to store data in or retrieve data from the database or other structure for collected data).

The virtual computer system may include a collection of computing resources configured to instantiate virtual machine instances. The virtual computing system and/or computers may provide a human-machine interface through which a user may interface with the virtual computer system via the offsite user device or, in some implementations, the onsite user device. In some implementations, other computer systems or computer system services may be utilized in the rig computing resource environment 105, such as a computer system or computer system service that provisions computing resources on dedicated or shared computers/servers and/or other physical devices. In some implementations, the rig computing resource environment 105 may include a single server (in a discrete hardware component or as a virtual server) or multiple servers (e.g., web servers, application servers, or other servers). The servers may be, for example, computers arranged in any physical and/or virtual configuration

In some implementations, the rig computing resource environment 105 may include a database that may be a collection of computing resources that run one or more data collections. Such data collections may be operated and managed by utilizing API calls. The data collections, such as sensor data, may be made available to other resources in the rig computing resource environment or to user devices (e.g., onsite user device 118 and/or offsite user device 120) accessing the rig computing resource environment 105. In some implementations, the remote computing resource environment 106 may include similar computing resources to those described above, such as a single computer or multiple computers (in discrete hardware components or virtual computer systems).

FIG. 3 shows a functional block diagram illustrating an example of the aforementioned top drive system 115 configured to drive a rotary drilling system 303, including a drill string 305 and a bottom hole assembly 306 (in combination, 305 and 306 may be referred to herein as a “drill string assembly”) in accordance with implementations of the present disclosure. The top drive system 115 can include, motor 137 (e.g., a top-drive motor and a gearbox), and sensors 135 and controller 139, which can be the same or similar to those previously described. Additionally, the top drive system 115 can include a VFD 309 that receives AC power 310, which has a substantially fixed frequency, and outputs AC power 311, which has a selectable, variable frequency. For example, the VFD 309 can include a rectifier 318 and a set of insulated-gate bipolar transistors (IGBT) 319 (e.g., an inverter) configured to convert the input AC power 310 to output AC power 311 having a particular frequency based on control signals 312 received from the controller 139.

The sensors 135 can determine sensor data 313, which can include various information measured at the rig 102. For example, the sensor data 313A can include, among other information, VFD output frequency, VFD output voltage, VFD output current, motor RPM, motor acceleration, and output torque. Additional measurements may be provided by sensors 135B (e.g., up-hole sensors installed below the top-drive, such as an instrumented quill sub) and by downhole sensors 164 installed in the bottom hole assembly 306 or along the drill-string 305. The data from the down-hole sensor 164 is transmitted by down-hole telemetry to the interface to down-hole system 110 which exchanges sensor data with the rig computing resource environment 106 and finally with the controller 139 of the top drive system 115. The sensor 164 may be related to down-hole torque, weight-on-bit or down-hole vibration. The down-hole telemetry 313B may be MWD wireless telemetry such as MWD mud-pulse telemetry or MWD E-mag telemetry). The sensors 135B can determine sensor data 313B and may be transmitted by conventional surface communication (such as WIFI, BlueTooth . . . ) to the controller 117 of the top drive system 115. In particular, the sensors 135B may be related to torque as measured at that particular level along the rotary drilling system 303. In implementations, the sensor data 313B can be provided to the controller 139 of the top drive system 115 via the interface to the downhole system 110 and the coordinated control device 104, as shown in FIG. 2). The sensor data 313 can be communicated via wired or wireless communication links. The wireless links can be conventional data communication (313B) or down-hole communication 313C which can be either based on MWD wireless telemetry (such as mud-pulse MWD telemetry or e-mag MWD telemetry), as well as any other down-hole communication system which may involve cable telemetry or wired-drill-pipe.

The motor 137 can be an induction motor that operates at the operating point which is the intersection of the specific response characteristics (torque versus RPM) (e.g., a virtual drive characteristic) and the drill string demand (torque versus RPM/ also called “load curve”) for the rotation of rotary drilling system 303, which includes the drill string 305 and the bottom hole assembly 306 in a wellbore. The specific response characteristics (e.g., a virtual drive characteristic) depends on the dynamic output of the controller 139, which sets the variable frequency of the AC power 311, as described below.

The controller 139 can include a data acquisition unit 315 that receives and conditions the sensor data 313 from the sensors 135. The controller 139 can also include a driver unit 117 that outputs control signals 312 for selecting the frequency of the AC Power 311 output by the VFD 309. For example, the driver unit 117 can include a programmable logic controller that generates the signal 312 that selectively switches the IGBT 319 in the VFD 309 to generate the variable-frequency AC power 311 provided to the motor 137. The controller 139, the VFD 309, and the sensors 135 and 164 can comprise a control system for driving the motor 137 and the rotary drilling system 303.

In implementations, the VFD 309 generates the variable-frequency AC power 311 for driving the motor 137 from the substantially non-variable-frequency AC power input 310. The VFD 309 can act as an adjustable-speed drive unit that adapts the power input 310 to provide the adjusted power 311 (amplitude and frequency) to the motor 137. The motor 137 may then operate at a given torque and speed as result of the match between the motor output characteristic (torque versus RPM) for the frequency of the output power 311 and the instantaneous demand (of torque versus RPM) of the rotary drilling system 303 (including the drill-string 305 and bottom hole assembly 306).

The output torque of the motor 137 can be measured directly in-line with the drill string 305 or on (or near) the shaft of the motor 137. For example, the output torque may be acquired on a quill, a motor shaft, or a gearbox of the top drive system 115. This could be obtained via the sensors 135B on from the rotary shaft of the drill string 305 via wireless telemetry 313B or even from a sensor 164 in the BHA 306 via the down-hole telemetry 313C The total motor torque can also be determined from the current fed by the VFD to the motor 137 (sensor 135A inside the VFD 309). This total motor torque can be substantially linear with respect to the drive current when the motor operates near the synchronization speed. However, the motor total torque may include two components: the torque output applied onto its drive shaft, and the torque applied to accelerate/decelerate the motor rotor. This torque is characterized as followed:

Tac=InRot accel=ot ∂Ω/∂t (1)

wherein:
Tac=torque for accelerating motor rotor;
InRot=Inertia of the motor rotor;
accel=rotary acceleration; and
Ω=rotary speed.

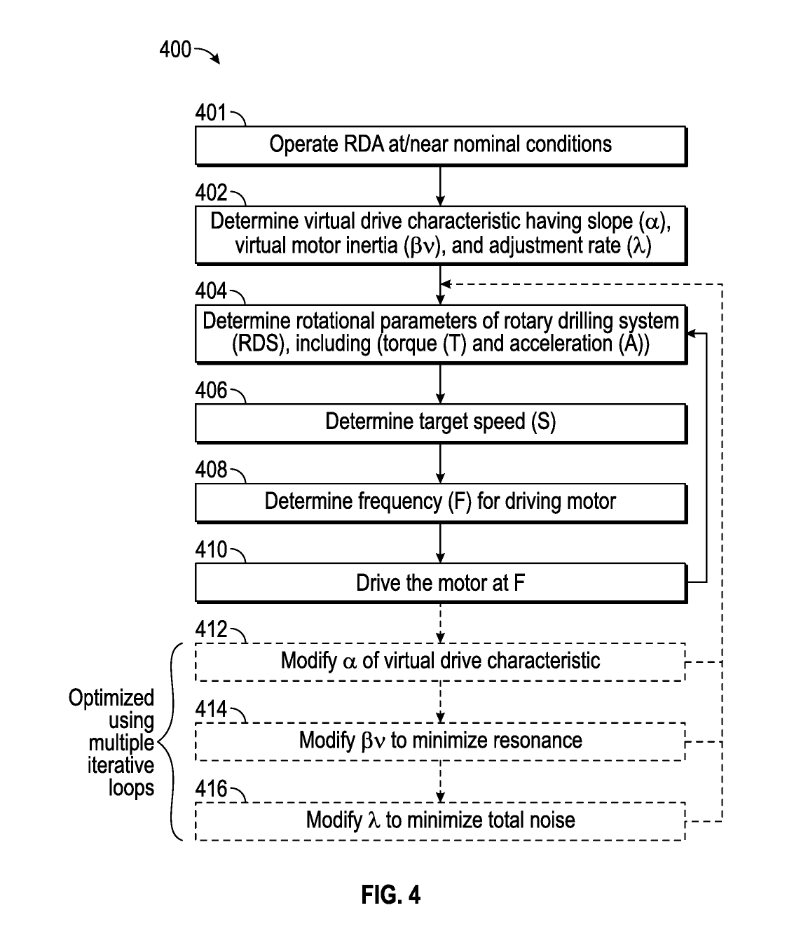

FIG. 4 shows a flow diagram illustrating an example of a process 400 for determining an induction motor response for controlling rotation variation (e.g., stick-and-slip and similar effects), according to an implementation. At 401, a rotary drilling system RDA (e.g., rotary drilling system 303, including drill string 305 and bottom hole assembly 306) can be operated with a torque and speed that are at or near nominal conditions. For example, nominal conditions may be provided by operating the rotary drilling system in a wellbore without making contact with a bottom of the wellbore such that there is substantially no weight on a bit of the drill string.

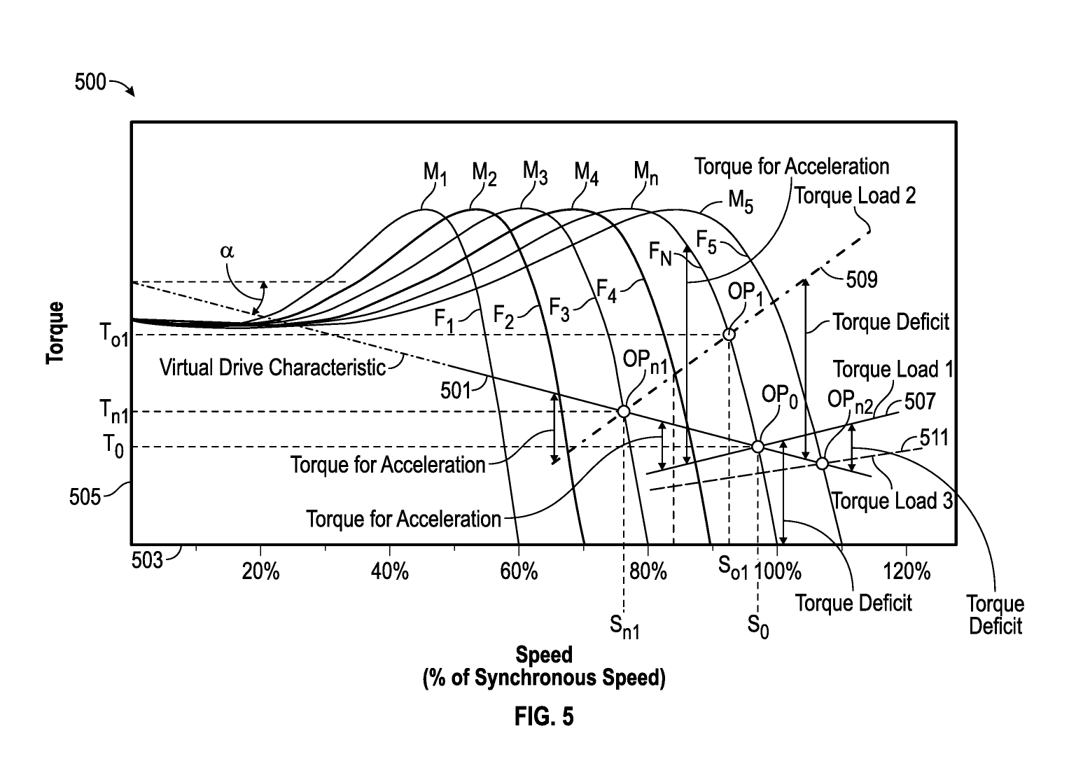

At 402, the process 400 determines a virtual drive characteristic having a slope (α), a virtual motor inertia (βυ, and an adjustment rate (λ). This determination may be performed using on pre-existing information of the system such as typical initial conditions, or results of previous operations. As described previously herein, the predetermined response of the virtual drive characteristic may represent a substantially linear relationship between the torque and that speed, which passes through a particular operating point (see, e.g., “OP” in FIG. 5) of the response of the top-drive system and has a slope (α). In implementations, the virtual drive characteristic defines a relationship between the speed and the torque provided by a motor (e.g., motor 137) in association with a range of frequencies of generated by a VFD (e.g., VFD 309) to the motor. The virtual motor inertia and the adjustment rate can be determined as detailed herein below and can be used to control the motor so as to modify resonance of the drill string assembly.

At 404, the process 400 determines rotational parameters of the rotary drilling system during actuation by the motor. The rotational parameters can include the actual torque of the rotary drilling system. The rotational parameters can also include other information of the drill string assembly, such its torque (T) and/or acceleration (A). These rotational parameters can be measurements of actual rotational parameters obtained from one or more sensors of the system (e.g., sensors 135) within the rotary drilling system.

At 406, the process 400 determines a target speed (S) for the rotary drilling system corresponding to the torque determined at 404 using the relationship between torque and speed defined by the virtual drive characteristic determined at 402. The new operating point OPₙ₁ is defined by this torque from 404 and this corresponding speed determined at 406.

At 408, the process 400 determines a frequency (F) for power driving the motor (e.g., AC power 311 output by VFD 309) based on the operating OPₙ₁ corresponding to the target speed determined at 406 and the rotational parameters (e.g., torque) as determined in 404 and the motor response characteristics (e.g., M1, M2, M3 . . . in FIG. 5). Such motor characteristics describes the motor response such as torque versus speed (RPM) for given frequency of the supply power (e.g., AC power 311). These motor characteristics may be obtained by initial motor testing or modelling. As detailed below with respect to FIG. 5, the determination 408 can involve selecting the motor characteristic (e.g., M3) that passes by the point defined by the operating point OPₙ₁ idefined by torque (T) (from 404) and the speed (S) from 406). This may be performed by a controller (e.g., controller 139) based on digital representation of the graph of FIG. 5.

At 410, the process drives the motor at the frequency determined at 408. For example, the controller can drives a set of IGBT (e.g., IGBT 319) at the selected frequency via a driver unit (e.g., driver unit 317). Based on predefined cycle, the controller can iteratively return to 404, so in a substantially continuous control loop from 404 to 410.

FIG. 5 shows a graph 500 illustrating an example of reference function describing a virtual drive characteristic relating torque, speed, and drive frequency of a motor driving a drill string, according to an implementation. In the example of FIG. 5, when the torque load changes from torque load 507 (“torque load 1”) to torque load 509 (“torque load 2”), the operating point of the rotary drilling system moves from OP₀ to OPₙ₁ (corresponding to torques T₀ to Tₙ₁, and to speeds S₀ and Sₙ₁, respectively) when applying a power 311 to the motor at optimized selected frequency by the VFD 309. In comparison to change in torque from T₀ to T₁ corresponding to OP₀ to OPₙ₁, a top drive system operating open loop would instead allow the operating point would have pass from OP₀ to OP₁ having a variation of torque from T₀ to T₀₁, which is substantially greater than the change in torque resulting from the virtual drive characteristic in accordance with the present disclosure.

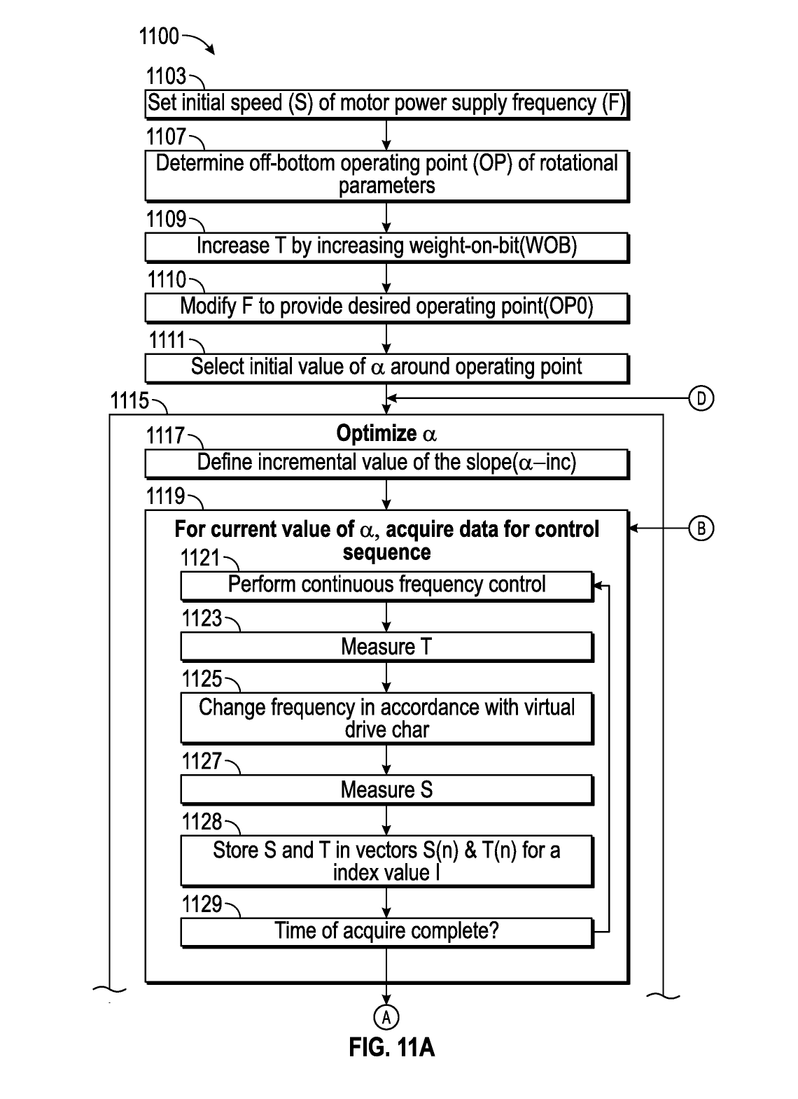

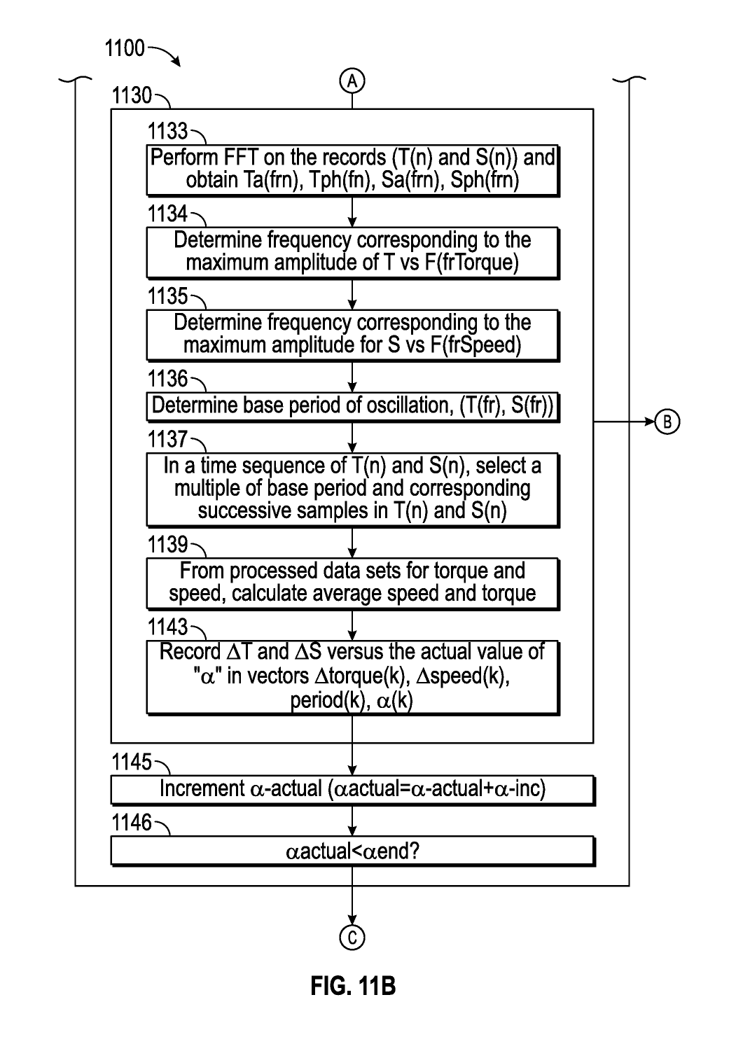

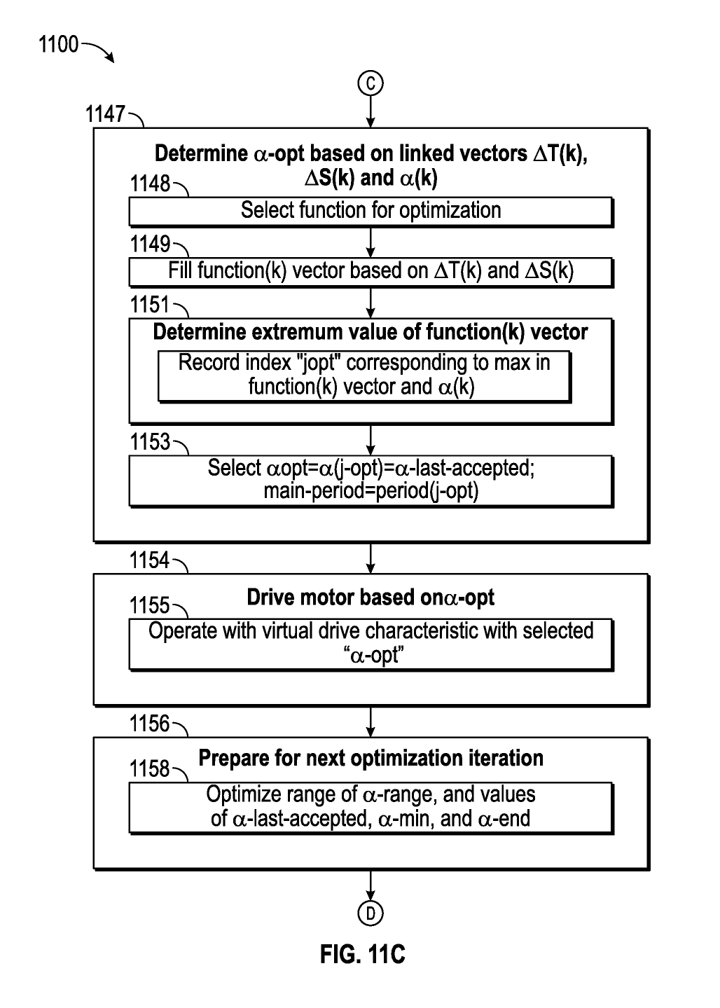

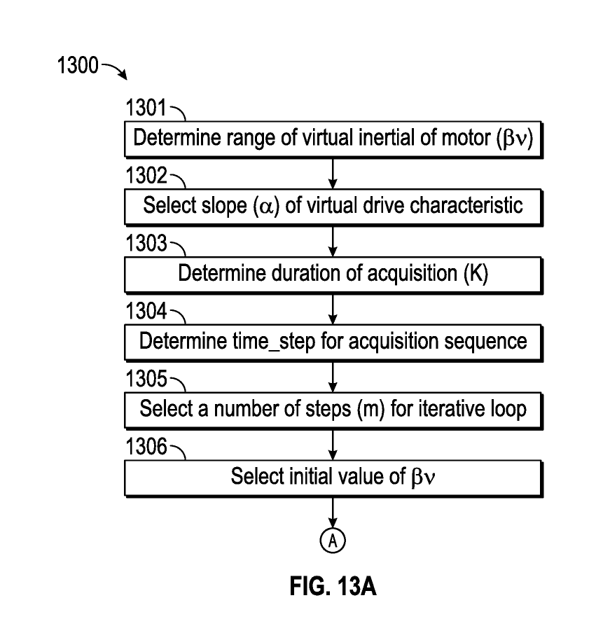

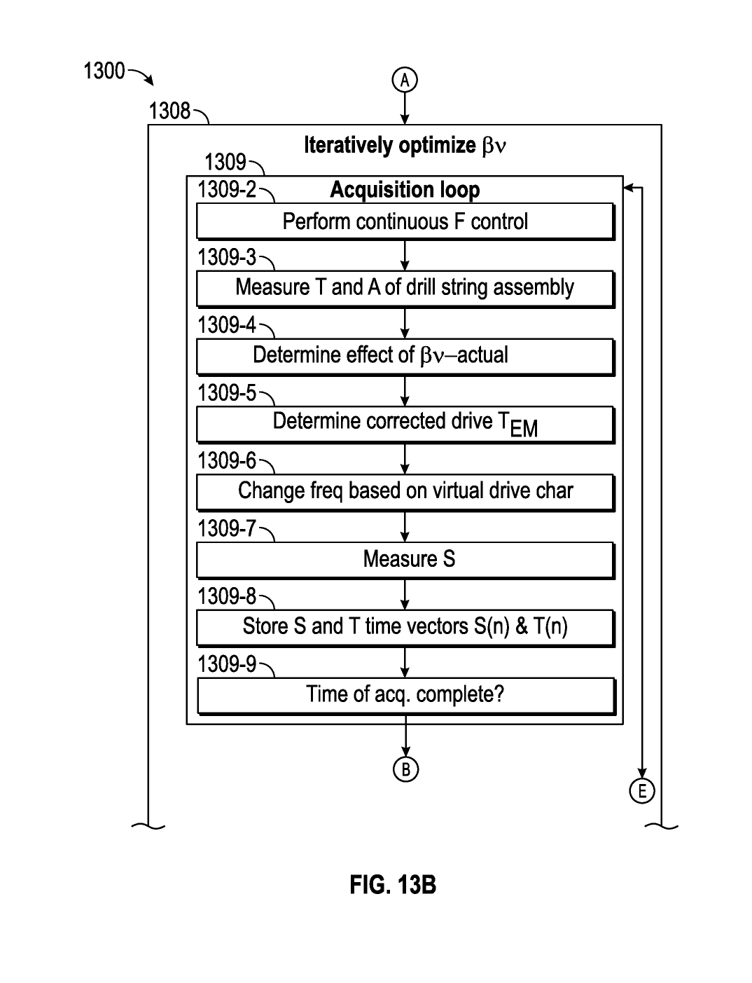

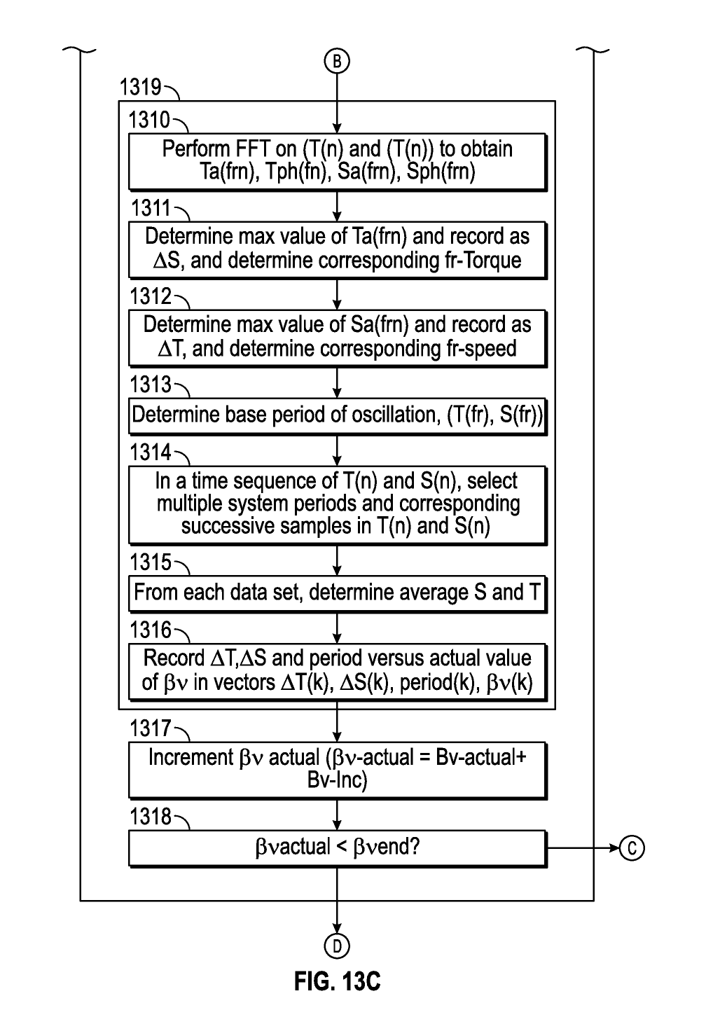

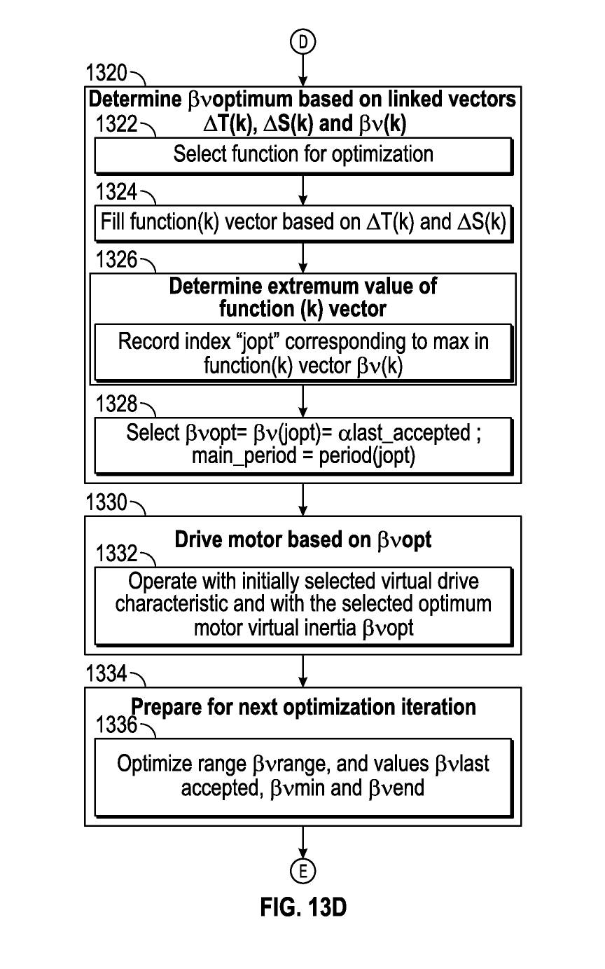

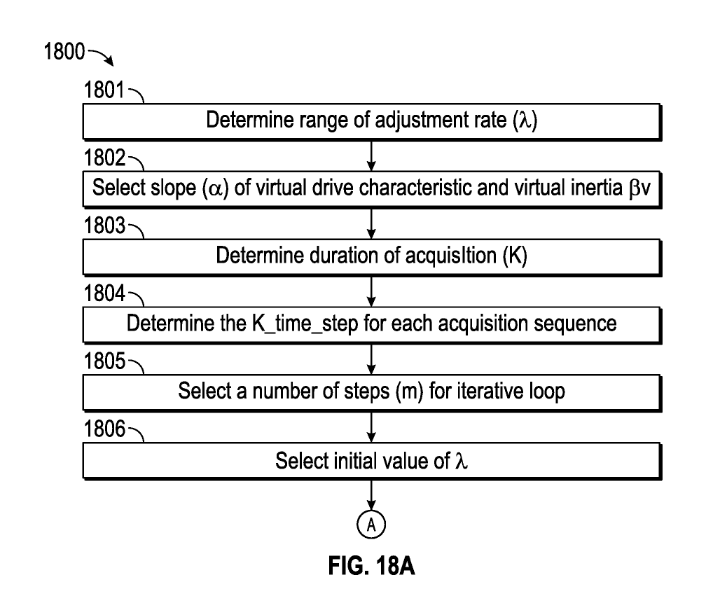

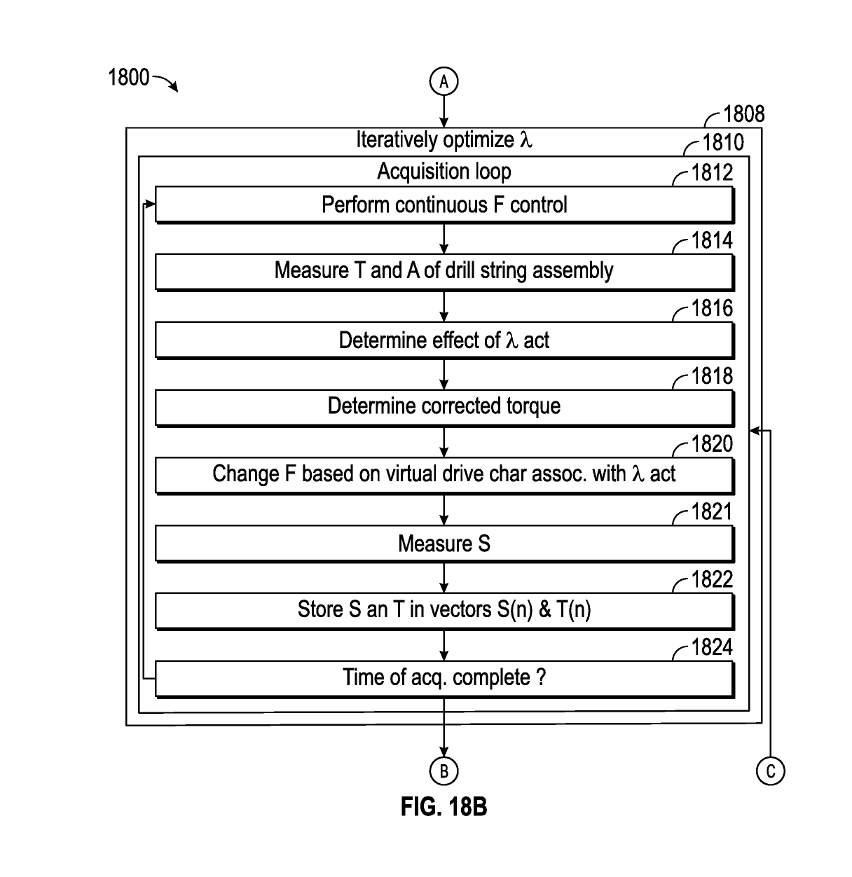

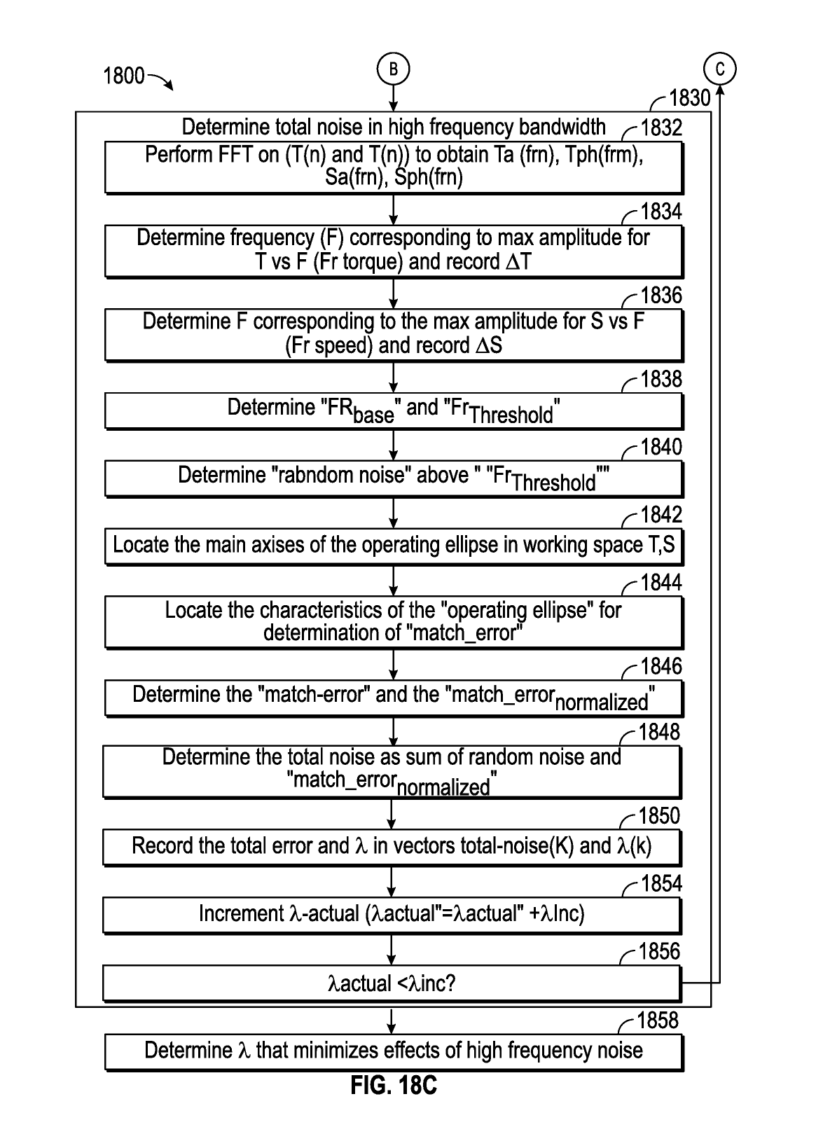

In accordance with aspects of the present disclosure, several optimizations can be included in the process 400 and are detailed herein below. In some implementations, at 412, the process 400 can modify the slope of the virtual drive characteristic initially determined at 402. In implementations, the slope of the virtual drive characteristic is optimized based on a function describing the matching of the drill string assembly to the top-drive system 115, as described herein with respect to, e.g. FIGS. 11A, 11B, and 11C. Additionally or alternatively, at 414, the process 400 can modify the virtual motor inertia, as described herein with respect to, e.g., FIGS. 13A-13D. For example, the modified virtual motor inertia can be used to iteratively determine a torque correction for the frequency determined at 408. Additionally or alternatively, at 416, the process 400 can modify the adjustment rate, as described herein with respect to, e.g., FIGS. 18A-18C. For example, the adjustment rate can be modified to change frequency of the power driving the motor.

The graph 500 describes the real motor response curves under various drive conditions, the desired motor response (called virtual drive characteristic) and the torque demand by the rotary drilling system. The graph 500 includes an x-axis 503, which is graduated in speed (or in percent of the synchronized speed of the motor when driven at its nominal frequency F_{N} and at zero-torque drive condition). The graph 500 also includes a y-axis 505 representing a range of torque that the motor can provide for the corresponding rotational speed. Further, the graph 500 includes a plurality of motor characteristic lines M₁ . . . Mₙ . . . M₅ representing the non-linear relationship between speed and torque the motor driven by power 311 having different frequencies F₁ . . . F_{N} . . . F₅.

The graph 500 also includes the “torque demand” (i.e., torque load) by the rotary drilling system (which includes the drill-string 305 and BHA 506). The torque demand is determined at the motor shaft which includes the correction due the potential presence of a reduction of gearbox. The torque demand represents an amount of torque supplied by the rotary drilling system to operate a given rotating speed under the current drilling conditions (e.g., current weight-on-bit, lithology, wellbore friction, bit configuration, wear, and the like.). The torque demand for the rotary drilling system may change as one or more of the drilling conditions change. Torque loads 507, 509, 511 represent some potential variation of torque loads.

Referring to FIG. 5, a motor (e.g., motor 137) can be driven by power (e.g., AC power 311) at a given frequency (e.g., FN) form a VFD (e.g., VFD 309). Due to this frequency (and also the voltage output of the power 311), operation of the motor following a given characteristic curve Mn. When the rotary drilling system (e.g., rotary drilling system 303) operates under a certain torque demand (e.g., torque load 507), an operating point OP₀ is defined as intersection between the motor characteristics Mn and the torque load 507. The operating point changes from OP₀ when the torque changes from torque load 507 to a different torque load 509 due to, e.g., changes in rotation conditions of the drill string assembly (e.g., variable friction between the drill string assembly and a wellbore). In the situations where the motor operates in open loop (e.g., without dynamic control by controller 139 based on feedback from sensors 135), the operating point may move from OP₀ to OP₁, which is not located on the virtual drive characteristic line 501. However, if the frequency of the fed power 311 is changed to F3, the operating point for the torque load 509 is OPₙ₁.

The graph 500 also represents the virtual drive characteristic 501 as a line having a slope (α) with respect to the x-axis 503 and the y-axis 505, and a reference operating point OP₀ (as intersection of the torque load 507 and the motor characteristic when driven by electrical power of frequency F_{N}. With reference to FIG. 5, the virtual drive characteristic 501 can be described as follows:

T=T0+α(S−S0), (2)

wherein:
T=torque,
S=speed,
T₀=torque at the desired nominal operating point,
S₀=speed at the desired nominal operating point, and
α=virtual drive characteristic slope. This slope may also be given as an angle α′, which is the arctangent (α)

As shown in FIG. 5, the initial operating point OP₀ is also on the virtual drive characteristic 501 due to the initialization process which will be described below. As already mentioned, when operating in open loop, the operating point moves from OP₀ to OP₁ on the same motor characteristic curve Mn, when the torque demand from the rotary drilling system changed from the torque load 507 to the torque load 509 away from the virtual characteristic line 501. Such change may be quite abrupt. In accordance with the present disclosure, the controller can control the motor to move the operating point OP₁ of the motor back to the virtual drive characteristic line 501 at the point OPₙ₁, which is at the intersection of the new torque load 509 and the virtual drive characteristic 501. Controlling the motor to operate at the operating point OPₙ₁ involves changing the frequency of the power fed to the motor 137 to the frequency F₃. Accordingly, systems and methods consistent with those disclosed herein can determine and selectively output power to the motor at the desired frequency F₃ such that the motor operates on torque response line M₃ instead of M_{N}. By doing so, the operating point of the motor changes from the initial OPₙ₁ to OPₙ₁ at the intersection with the virtual drive characteristic 501.

FIG. 5 also illustrates the case of lowering of the torque demand to, e.g., torque load 511 (“torque load 3”). By applying similar consideration as before, the new operating point would move to OPₙ₂, which is on the virtual drive characteristic 501 and corresponds to a frequency F₅ for the power output to the motor. The above-described control can be continuously performed by the controller as the torque demanded by the drill string may continuously change during operation. In reference to FIG. 5, the drill-string assembly may be accelerated (or decelerated) by the available torque for acceleration (or torque deficit). Such available torque (or deficit) represented along a vertical line from the virtual drive characteristic and the motor characteristic corresponding to the drive frequency. With such consideration, it is evident in FIG. 5 that the available torque (deficit) is smaller when operating in accordance to a virtual drive characteristic than in open loop. Hence, the acceleration (and so speed adjustment) of the drill string may be slower when operating in close-loop mode with a virtual drive characteristic than in open loop operation.

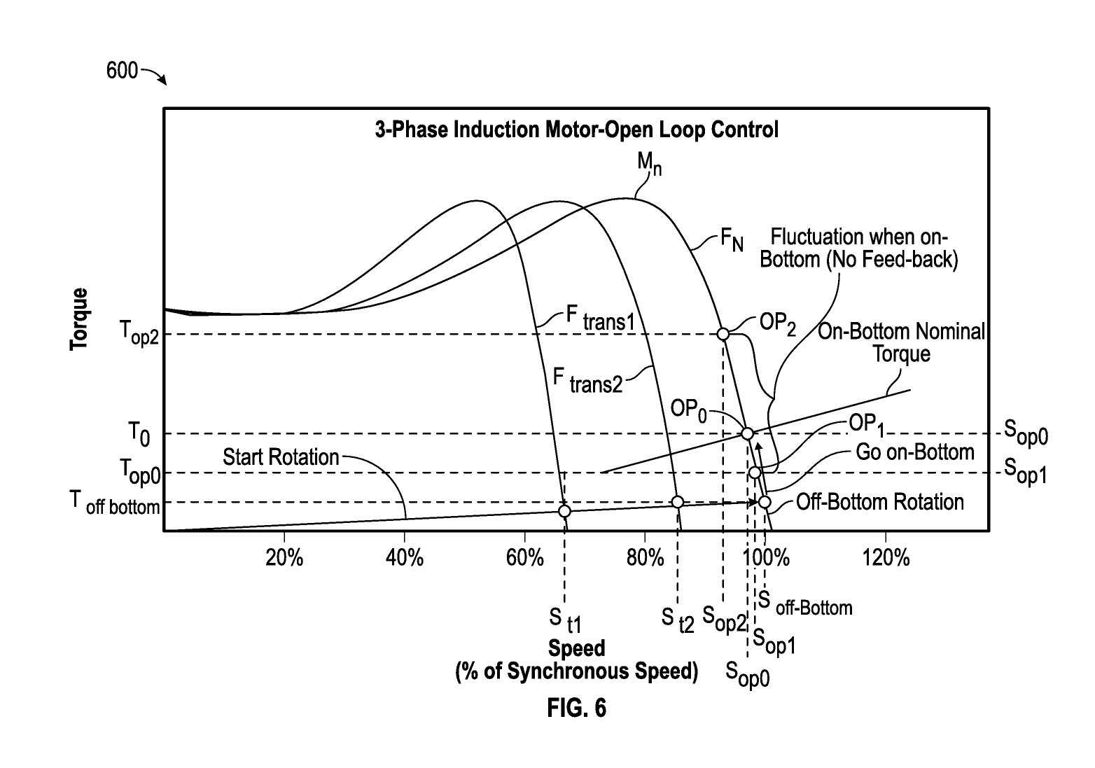

FIG. 6 shows a graph 600 of related to a motor driving a rotary drilling system (e.g., rotary drilling system 303), including reference function illustrating an example of a nominal operating point selection for a motor (e.g., motor 137), according to an implementation. More specifically, a frequency of power (e.g., AC power 311) to the motor can be increased progressively to a nominal frequency (F_{N}) so that the rotary drilling system (e.g., drill string 305 and bottom hole assembly 306) rotates at a desired speed. Initially, the motor torque T_{off-bottom} may be small when a bit of the drill string assembly is off a bottom of a wellbore. When the rotary drilling system is lowered in the wellbore so that the bit engages the bottom of the wellbore, the weight-on-bit increases and the torque on the rotary drilling system increases. As the nominal frequency of the VFD has not changed at this point, the motor operates on the characteristic line of the motor (M_{N}). Yet, the torque may oscillate between values T_{OP1} and T_{OP2} due to variations of friction between the rotary drilling system and the wellbore, as well as due to variation of engagement of the drill bit in the wellbore bottom due to the typical unsteady transmission of weight-on-bit.

In accordance with aspects of the present disclosure, an operating point OP₀ can be selected between OP₁ and OP₂. The operating point OP₀ can be, for example, an average of OP₁ and OP₂ based on torque versus time response while drilling. In should be understood that this OP₀ is a theoretical reference as operating point (to be used for later processing), as in reality the control of weight-on-bit determines the torque. In implementations, different filters can be applied to the torque versus time before such averaging. Such filter could be low pass filter with a cut-off point selected to minimize the effect of the variation of weight-on-bit. In other implementations, the operating torque can be selected to organize a set of torque measurements made during a selected time-window, where the torque is considered sufficiently steady fit into a torque histogram comprises of N different bins of different torque ranges. The bins in the histogram in having the greatest amount of content could be averaged to determine OP₀. It should be also noted that the operating point OP₀ stays constant only if the nominal weight-on-bit is not changed, as well as the lithology has not be changing due to the fact the hole is becoming deeper.

When the operating point OP₀ has been determined, the corresponding torque and speed can be considered as characteristics of this operating point. Such characterization may be obtained from the motor characteristic line of the motor (M_{N}) or from the data obtained during the selected time-window for determination of the operating point. For a selected OP₀, then the slope of the virtual characteristic line may be defined.

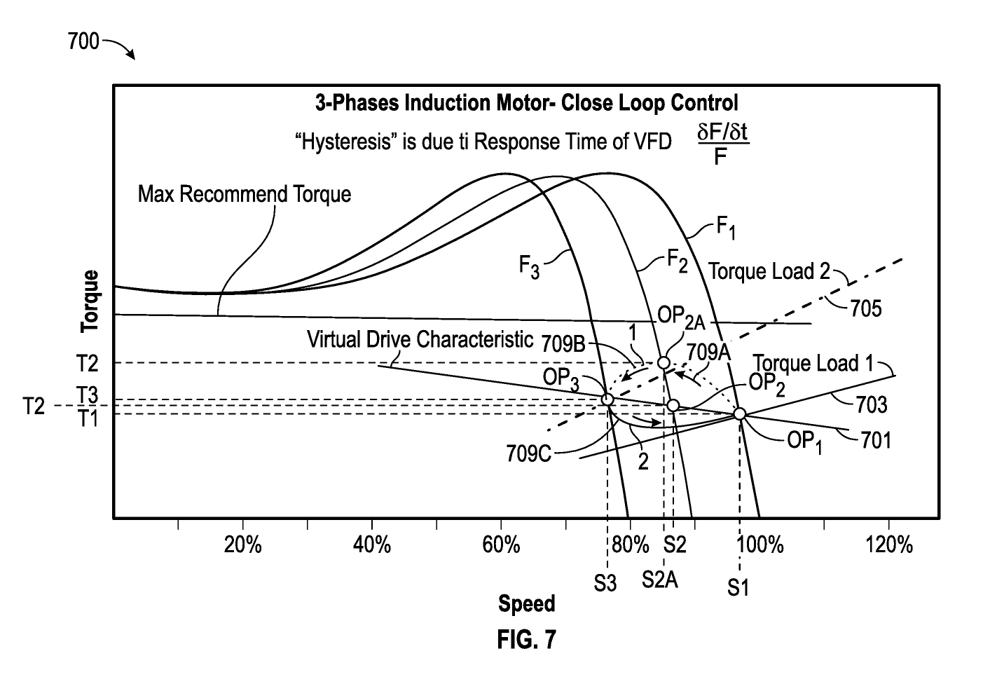

FIG. 7 shows a graph 700 of a drill string reference function illustrating an example of virtual drive characteristic 701 at a nominal operating point of a motor (e.g., motor 137), according to an implementation. A first torque load 703 on the aforementioned drill string assembly at a nominal drilling condition OP₁ (e.g., steady drill operation on well bottom without stick/slip and without variation of rotation conditions) corresponding to the torque loading imposed by the drill string. The virtual drive characteristic 701 can define a first speed S1 for the motor associated with a first torque output T1 obtained by a controller (e.g., controller 139) driving the motor with power (e.g. AC power 311) having the first frequency F1.

For a second torque load 705, occurring due to, e.g., increase of friction at the rotary drilling system, the virtual drive characteristic 701 can define an operating point OP₃ corresponding to a speed S3 and torque T3 while the frequency of the power generated by the VFD is F3. If the drill string demand suddenly changes from the first torque load 703 to the second torque load 705, the controller can adjust the frequency of power supplied to the motor 137. The adjustment may be performed in progressive fashion, so that the frequency would change progressively from F1 to F3 via one or more intermediate frequencies, such as F2.

The second speed S 2 for the motor that is associated with a second torque output T2 can be obtained by setting the power supplied to the output frequency F2. The operating point OP₂ may not be exactly on the line representing the virtual drive characteristic 701 due to some delay in the setting process (e.g., due to limited speed of response for the system). As such, the operating point OP₂ may be displaced as shown in FIG. 7 (shown as point OP_{2A}). Further, for a third operating point OP₃ may be present the continuation of the application of the torque load change due to, e.g., stick-and-slip the virtual drive characteristic 701 can define a third speed S3 for that is associated with a third torque output T3 obtained by supplying power having a frequency F3.

Additionally, FIG. 7 illustrates a situation in which the system returns to the nominal operating point OP₁. Arrows 709A, 709B, and 709C indicate the evolution of the operating point corresponding to a single example of a variation of the torque load from torque load 703 to torque load 705. In accordance with aspects of the present disclosure, the virtual drive characteristic 701 defines a substantially linear relationship between torque and speed to be provided by the motor so that the corresponding operating conditions (e.g., torque and speed) are on one straight line in the graph 700 of torque versus speed. The controller can continuously monitor the torque and speed of the drill string assembly (e.g., via sensors 135). The controller can also continuously identify the present (e.g., actual) operating condition in the graph 700 and determine the separation of this current operating point versus the virtual drive characteristics 701. If the present operating point is above the virtual drive characteristic 701, the control system lower can the output frequency of supply power driving the motor. For example, the point OP_{2A} is above the line representing the virtual drive characteristic 701. Accordingly, the controller can progressively reduce the frequency of the supply power to modify the present operating point OP_{2A} and progressively move it (e.g., via arrow 709B) towards the bottom left corner of the graph. With such progressive frequency adjustment, the operating point will located at OP₃, which is the intersection of the virtual drive characteristic 701, and the line representing torque load 703 (imposed by the drill string behavior in the wellbore under the current drilling condition such as weight-on-bit). It should be recognized that, the opposite adjustment would be imposed by the control system if an operating point of the motor were located below the virtual characteristic line 701 to progressively increase the frequency of the supply power. In reference to FIG. 5, the torque demand by the drill-sting assembly may reduce (as passing from the torque load 507 to 511). If such case, the system can increase the frequency of the supply power to keep the operating point OPₙ₂ on the virtual drive characteristic 701.

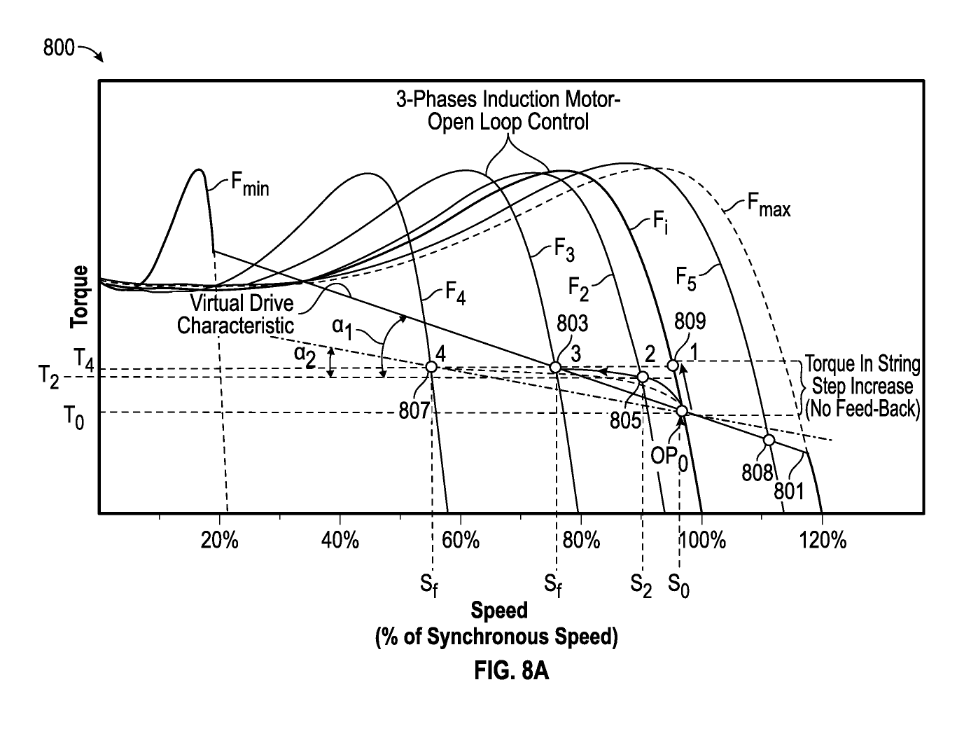

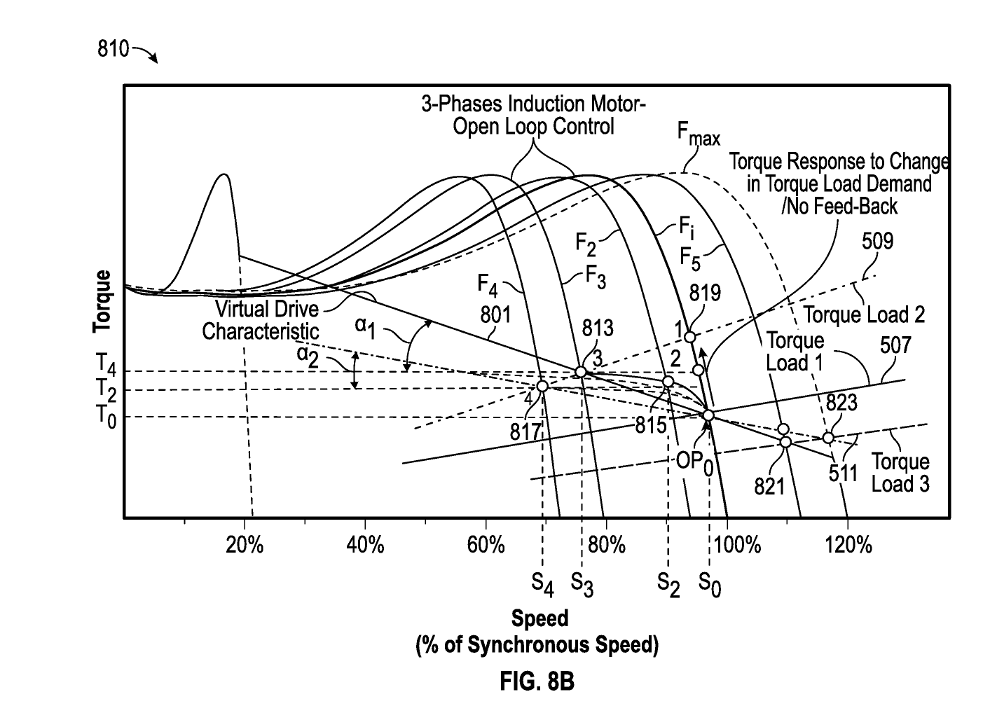

FIG. 8A shows a graph 800 of a drill string reference function illustrating an example of a system output, according to an implementation. More specifically, FIG. 8A depicts a limit of adjustment between the minimum and maximum frequencies (shown as Fmin and Fmax) of power (e.g., AC power 311) output to a motor (e.g., to motor 137 by VFD 309). FIG. 8A also shows the influence of selected different virtual drive characteristic 801 when a sudden increase of torque (e.g., a step function) is applied onto a drill string (e.g., drill string 305 and/or bottom hole assembly 306). The system would normally operate at the operating point OPₙ₁ before the torque increase and then can move to the operating point 803 by passing via an intermediate operating point such as 805 during the time of adjustment of the frequency of the power (e.g., under control of controller 139) and when operating under a selected virtual drive characteristic of slope α1. However, the final operating point after the torque step would the point 807 if operating following the virtual drive characteristic of slope α2. It should also be noted that in open loop operation, the final operating point after the torque step would be the point 809. Notably, the virtual drive characteristic 801 is determined based on a definition of an operating point OP₀ at T0, S₀ and slope α. The operating point (T₀, S₀) can be determined by an operator of the system, such as described above. When operating at OP₀, if the torque step function is involving a reduction of torque, the operating point would move to the right from OP₀ to the point 808 to stay on the virtual drive characteristic to operating point 808, while a controller (e.g., controller 139) of the system would set the frequency of the supply power to frequency F5.

FIG. 8B shows a graph 810 of reference function for a motor driving a drill string illustrating an example of a system output, according to an implementation. More specifically, FIG. 8B depicts an example of the limit of adjustment between the minimum and maximum frequencies of VFD output (shown as Fmin and Fmax). FIG. 8B also shows the influence of selected different virtual drive characteristic 801 when a change in the torque load (demand) is occurring along the rotary drilling system. The system would normally operate at the operating point OP₀ before a torque increase and then can move to the operating point 813 by passing via an intermediate operating point such as 815 during the time of adjustment of power supply frequency when operating under a selected virtual drive characteristic of slope α1. However, the final operating point after the torque step would the point 817 if operating following the virtual drive characteristic of slope α2. It should also be noted that in open loop operation, the final operating after the torque step would be the point 819. If the change of torque load (from torque load 507) to torque load 511) corresponds to a reduction of torque demand by a drill string assembly (e.g., drill string 305 and bottom hole assembly 306). The new operating point may become 821 when operating with the virtual drive characteristic of slope α1, while being 823 when operating with the virtual drive characteristic of slope α2. Again, notably, the virtual drive characteristic 801 is determined based on a definition of an operating point OP₀ at T₀, S₀ and a slope α. The operating point (T₀, S₀) corresponds to a selection made by an operator, such as described above.

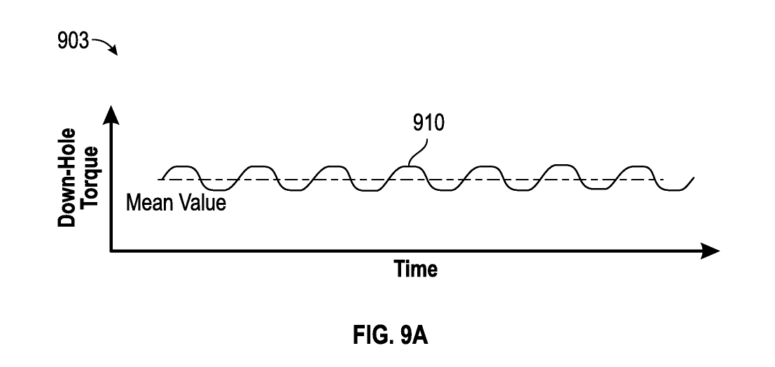

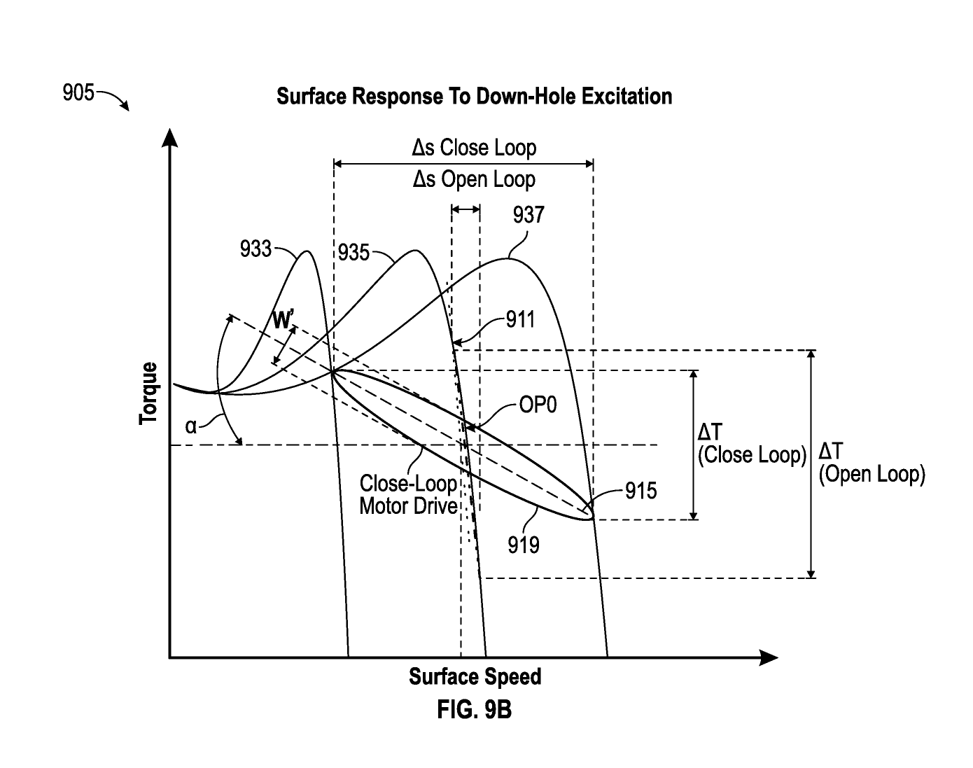

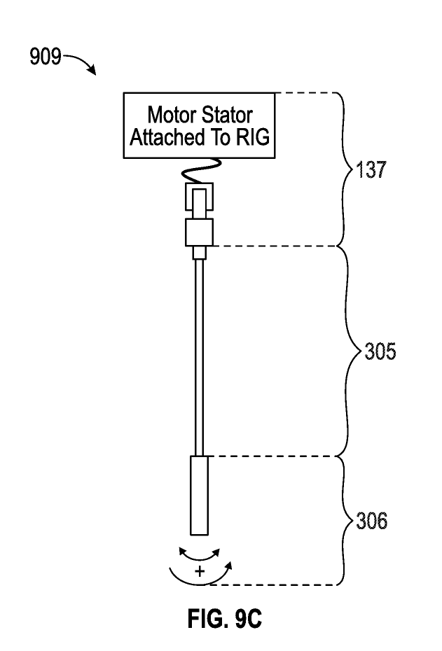

FIGS. 9A and 9B show graphs 903 and 905 illustrating responses for an example system 909 shown in FIG. 9C, according to an implementation. More specifically, FIG. 9A shows a graph 903 depicting a down-hole combination of average torque and fluctuation in torque affecting operation of the rotary drilling system of the system 909, including, a drill string 305, and a bottom hole assembly 306 which includes a drill-bit(not represented), which is rotated by a motor 137 inside the wellbore. As described previously, variation of rotational conditions may occur due to change in friction factor between the rotary drilling system and the wellbore or at the contact of the drill-bit and the bottom of the wellbore. Such effects influence the torque demand within the wellbore as shown in graph 903 of FIG. 9A. For example, during operation, a torsional wave 910 may propagate in the drill string 305 and the bottom hole assembly 306, which can create fluctuations in torque and/or speed at the surface or at the motor 137. In such case, the system 909 may behave as shown in the graph 905 of FIG. 9B. The graph 905 depicts a similar version of the FIG. 8B when torque oscillation is occurring along the system 909 In case of open loop operation 911, the variation of torque can be large, while the corresponding variation in speed is small. By operating in close-loop control following a virtual drive characteristic 915, the variation of speed is larger while the corresponding variation of torque is smaller. During a full oscillation cycle of torque due to the wave propagation, torque and speed can oscillate around the nominal operating point OPO (e.g., selected by an operator). If a response of the system 909 (including sensors, controller, VFD, and motor response) were infinitely fast, the response would follow the virtual drive characteristic line 915 in the graph (upper left corner). Due to limits in response speed (limited adjustment rate), however, the system 909 may actually follow an elliptical pattern 919 when operating in close-loop (e.g., as shown in FIG. 3). The width W of the elliptical pattern 919 depends on the response speed (adjustment rate) of the system including the motor, the VFD and the closed loop system. This graph 905 also shows also three different motor characteristics 933, 935, 937 when the motor (e.g., motor 137) is driven at three different frequencies (e.g. using the controller 139 and the VFD 309). The characteristics 935 corresponds to the nominal motor operation as it passes by the nominal operating point OPO. The characteristic 933 corresponds to the motor operation of the motor 137 at the minimum frequency of the power 311 generated by the VFD 309 during a single oscillation loop. The characteristic 937 corresponds to the motor operation of the motor 137 at the maximum frequency of the power 311 generated by the VFD 309 during a single oscillation loop.

The selection of the virtual drive characteristic 915 affects the response of the system 909 when operating under closed-loop control. This virtual drive characteristic 915 can be determined as described below with regard to FIGS. 11A- 11 C. In an implementation, the virtual drive characteristic 915 can be determined by determining extremum of a reference function describing the behavior of the drill string assembly. The reference function can be, for example, an algorithm, a dataset, a mathematical relation including torque and or speed as input, or a predefined model of the drill string (e.g., stored in rig computing resource environment 105) that defines a correspondence between torque on the drill string assembly and the rotational frequency of the drill string assembly during typical rotation oscillation (e.g., a cycle of torque oscillation due to stick-slip). This function depends on the slope (α) of the virtual characteristic drive 915. In an implementation, the slope α of the virtual drive characteristic 915 can be optimized based on the use of the following function:

Osc-Power-App(α)=K₁ ΔT(α) ΔS(α) (30)

where:
ΔT(α)=variation of torque during one typical oscillation cycle when operating with the slope α; and
ΔS(α)=variation of the drill string rotational speed during one typical oscillation cycle when operating with the slope α.

ΔT(α) and ΔS(α) are represented as ΔT-close-loop and ΔS-close-loop in FIG. 9B, as this graph relates to a single value of α. Function such as Osc-Power-App(α) can be generalized as F(ΔTorque, ΔSpeed) and called “improvement function”

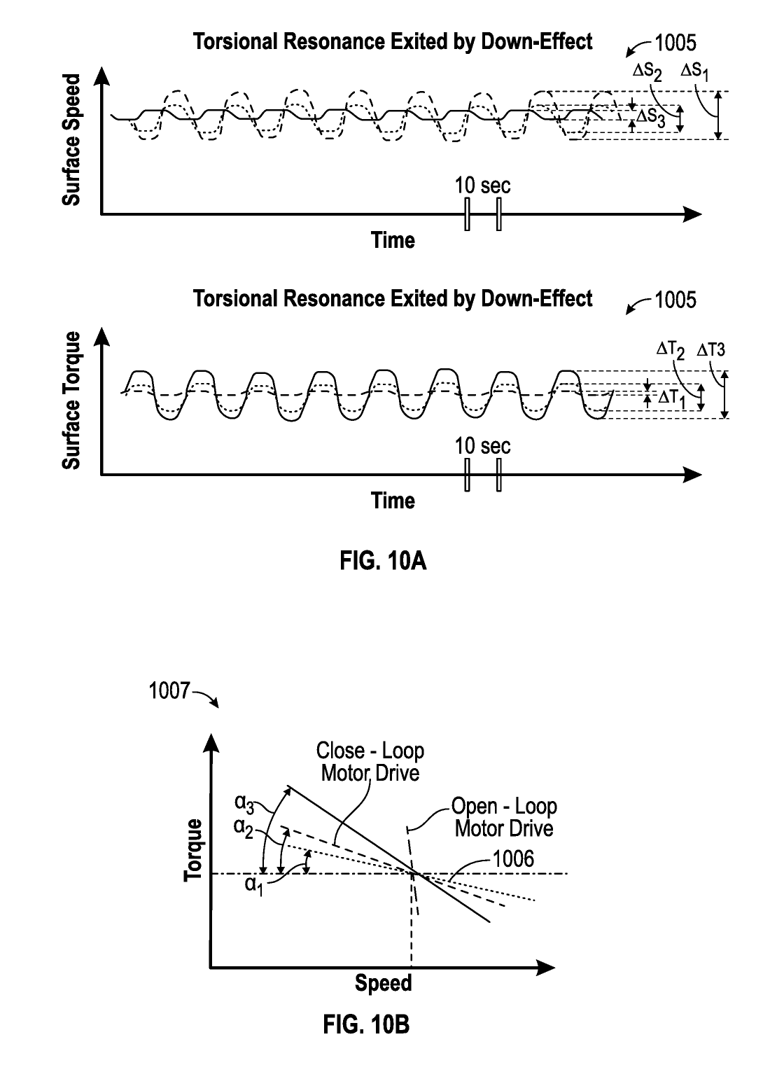

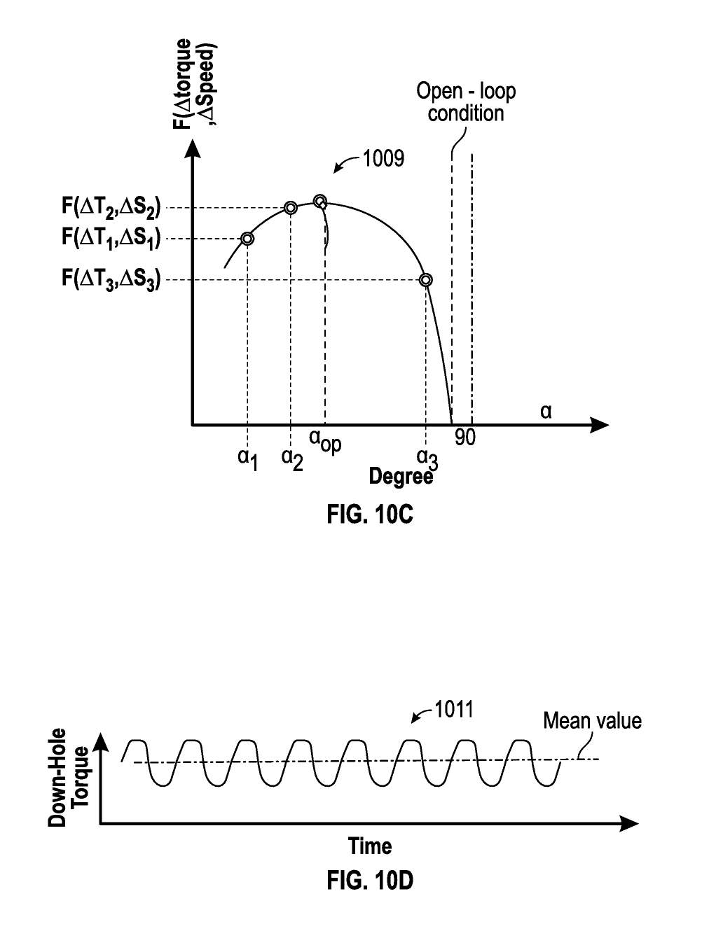

The system 909 can be controlled (e.g., by controller 139) to operate during successive periods of time with different values for the slope of the virtual drive characteristic 915 to determine the values ΔT(α) and ΔS(α) via a graph 905 (FIG. 9B) for each value of a, and then to generate information (such as graph 1009 in FIG. 10C) which relates the value of a function (3) versus α allowing to determine a particular value of the slope corresponding to the maximum of the function (3) over the successive periods. During these successive periods, the variations torque (αT) and speed (ΔS) can recorded in relation with the slope of the virtual drive characteristic (α).

FIGS. 10A-10D show graphs of a system output, according to an implementation. More specifically, an implementation of the above improvement function (3) is represented in the FIG. 10A. The graph 1005 of FIG. 10A represents measurements (e.g., torque and RPM) from sensors (e.g. sensors 135) performed by a top-drive (e.g., top drive system 115) during successive periods, wherein a slope of a virtual drive characteristic lines 1006 (e.g., virtual drive characteristic 915) has been set a selected value (α1, α2, α3 . . . ). FIG. 10D illustrates a graph 1011 of the corresponding downhole torque.

The slopes of the virtual drive characteristic lines 1006 are shown in graph 1007 of FIG. 10B. For each period corresponding to a given 60 , ΔT and AS are determined for the “close-loop” operation, as shown in graph 1005 of FIG. 10A. For each period, the value of the improvement function (3) can be calculated based on these determined values of ΔT and ΔS. Then, the result of the improvement function (3) is plotted versus the slope a of the virtual drive characteristic in the graph 1009 of FIG. 10C. After sufficient steps of value α, the graph 1009 of FIG. 10C allows a determination of the extremum of this improvement function (3) and the corresponding optimum slope of the virtual drive characteristic (αₒₚ).

It should be noted that ΔT(α) and ΔS(α) of the improvement function (3) can be determined either the information recorded versus time, such as shown in the graph 1005, or in the graph of torque versus speed such as shown in graph 905 of FIG. 9B. It should also be noted that the coefficient K1 of improvement function (3) has no influence on the determined optimum value of the slope of the virtual drive characteristic. For example, the improvement function (3) above characterizes the capability for the system to manage a travelling wave alternately as torque that deforms elastically the string or a kinetic energy thanks to the un-steady rotation speed. Another potential improvement function which may be used is:

Impedance(α)=IΔT(α)/ΔS(α)−αI (4)
where ΔT(α)/ΔS(α) represents the mechanical impedance of the system.

When the improvement function (4) (based on mechanical impedance) is minimized, drill string impedance matches the apparent drive impedance, allowing the best energy transfer between the drive system and the receiving system assembly. With such impedance function (4), the improvement corresponds to the minimum of the function versus the slope of the virtual drive characteristic.

Other improvement functions which may be used are:

Energy(α)=K₁ ΔT(α)²+K₂ ΔS(α)² (5)

Or

Reduced_Energy(α)=ΔT(α)²+K₂/K₁ ΔS(α)² (6)

In the reduced energy function (6), the ratio K2/K1 may be described by the torsional rigidity of the drill string and its inertia. This ratio can be estimated by the usage of a model of the rotating drill string in the contact with wellbore. The model can be a torsional mechanical resonator of a mode of resonance (with one resonance frequency). It can be represented as a lumped inertia and a torsional spring. However, a complex mechanical model of the drill string may be considered. It is understood that other functions could be used for improvement and selection of a slope of the virtual drive characteristic to the extremum.

When the optimum slope of the virtual drive characteristic has been determined, the controller (e.g., controller 139) may control the operation of the motor in accordance with the corresponding virtual drive characteristic, as explained previously herein. Further optimization of the slope of the virtual drive characteristic may be performed by the system if the drilling conditions are changing such as changing drill-bit or rock to drill, or even well trajectory, as these parameters may affect the improvement function (3).

FIGS. 11A-11C illustrate a flow diagram of a process 1100 for determining a virtual drive characteristic for a motor combined with drive electronics actuating a rotary drilling system, according to an implementation. At 1103, the process 1100 (executed by, e.g., controller 139) sets an initial speed (S) of a motor (e.g., motor 137) by generating (e.g., using VFD 309) supplied power (e.g., AC power 311) having a selected frequency (F) that rotates the motor at or near the initial speed (e.g., determined by an operator). For example, the speed of the motor can be set by progressively increasing the frequency of the supplied power driving the motor that rotates a drill string assembly (e.g., drill string 305 and bottom hole assembly 306). In implementations, the speed can be set while the drill string assembly is off-bottom of a wellbore to minimize torque to initially rotate the drill string assembly during a starting phase. This initial stetting can performed open loop (e.g., without dynamic control by controller 139 based on feedback from sensors 135).

At 1107, the process 1100 determines an off-bottom operating point of rotational parameters (e.g., torque and/or speed) for the drill string assembly by increasing frequency of the supplied power from the initial speed set at 1103 until a nominal the operating point (see, e.g., FIG. 6) is achieved based on using information received from sensors (e.g., sensors 135). For example, the nominal operating point can be the mean velocity speed of the rotary drilling system measured while the motor is driven at the frequency selected at 1103

At 1109, while the drill string assembly is driven at the speed in the vicinity of the operating point determined at 1107, torque may be increased by indirect effect, such as lowering the drill-bit in contact with the bottom of the wellbore, which increases the weight-on-bit and, thereby, increases its cutting action.

At 1110, the frequency of the supplied power can be modified (typically increased) to ensure that the motor rotates at (or near) the desired operating point (OP₀) (e.g., rotational speed (RPM)) in presence of the increased torque. The drill string assembly can be kept in such state for a period of time to allow averaging of the torque and speed around the nominal operating point initially determined in 1107.

At 1111, the process 1100 selects an initial value for a slope (α) of a virtual drive characteristic that also passes by the operating point determined at 1107. This initial value of the slope can be either a last accepted value (α-last) or a middle value (e.g., α-average) of a pre-defined range for the slope (α-range). A default range of the slope can also be selected. If not initially limited, the range can be the frequency range of regulation that a VFD (e.g., VFD 309) to provide the supply power to the motor. For example, the frequency may range from 5 to 100 Hertz. In some implementations, the initial value of αmin can be set to equal “αlast−½ ”αrange. A final value “α-end” can equal “α-last-accepted+½ α-range.”

At 1115, the process 1100 optimizes the slope of the virtual drive characteristic. At 1117, an incremental value of the slope (α-inc) can be defined, wherein:

α-inc=α-range/m (7)
wherein “m” is an integer corresponding to the number of iteration loop to optimize α.

In implementations, at 1119 the process 1100 can iteratively perform a control sequence in view of determination the optimal value of the slope (α-opt) of the virtual drive characteristic of 1115 over “m” potential values of the parameter a within the acceptable range defined by a minimum slope (α-min) and end slope (α-end). Optimizing the slope at 1115 can include two elements 1119 and 1130, wherein 1119 acquires the data for the given control sequence corresponding to one value of a and 1130 performs processing related to the acquired data in relation with that value of α.

Using the initial value of the slope selected at 1111 or at 1158 (below), for iterations of data acquisition in 1119 on the slope of the virtual drive characteristic, the value of slope represents the actual slope (i.e., α-actual) The process 1100 operates during a certain iteration time (T-iteration) while using the virtual drive characteristic defined with the actual slope and passing by the selected operating point determined at 1103 associated with 1109. The time (T-iteration) for the individual iterations can be a value selected to be longer than the period of the string oscillation (due to, e.g., stick and slip process) and, in implementations, encompass several such periods (e.g., 3 to 10 periods). This period of iteration time can be referred to as an “acquisition sequence.”

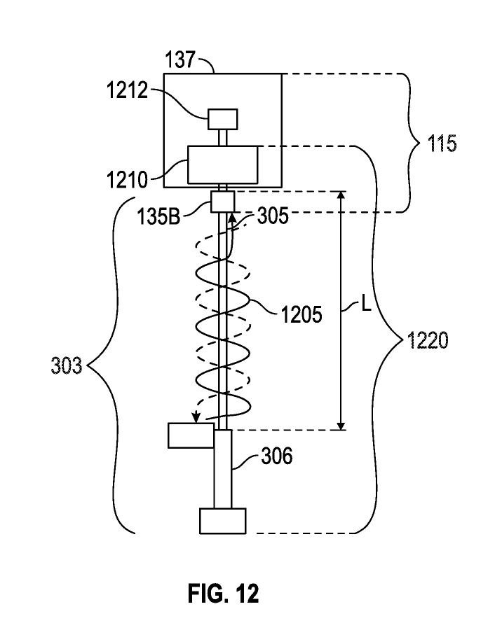

FIG. 12 shows a block diagram illustrating an example of a rotary drilling system, according to an implementation. As shown in FIG. 12 (described below), for example, a drill string assembly rotates in a wellbore with some oscillation. During the acquisition sequence, several cycles of the oscillation are recorded as shown in graph 1005 of FIG. 10 A. And, as shown in, e.g., FIG. 9B (described above) and FIG. 10B (described above), the individual oscillation cycles of the drill string assembly corresponds to a full cycle on the elliptical set of settings (torque versus speed). For example, the acquisition sequence can cycle for at least two longest oscillation cycles (e.g., about 20 seconds). During this acquisition sequence, the drill string assembly can kept in rotation in accordance to the application of the virtual drive characteristic applied by the controller to drive the motor with the supply power (e.g., from the VFD). Due to variable friction and other forces inside the wellbore, the torque at the top of drill string assembly varies.

As described previously herein (e.g., in relation with FIGS. 7 and 8), the controller can dynamically adjust the frequency of the supply power provided to the motor so that the actual operating point stays on or close to the virtual drive characteristic. For example, with reference, e.g., to FIG. 7, and starting at operating point OP₁ (while α-actual is selected), the iterative control sequence of 1119 can select F 1 as an output frequency. OP₁ is on the torque load 1 corresponding to mean operating condition in the wellbore. When torque demand increases in the wellbore, the controller can reduce the frequency of the supplied power to F2. The operating point is OP_{2A} may stay slightly above the virtual drive characteristic due to, for example, lag in system, while OP₂ (in FIG. 7) would be the target operating point corresponding to F2.

Referring back to FIG. 11A, at 1121, the data acquisition of 1119 can continuously (or based on a time increment) control the motor driven by varying the frequency of its supplied power within a frequency range (e.g., 5 Hertz to 75 Hertz). The data acquisition of 1119 can correspond to N steps to cover the iteration time (T-iteration), where time_step=T-iteration/N. At 1123, the data acquisition of 1119 measures actual torque (T) occurring, e.g., at top of the drill string assembly (using, e.g., sensor 135B). At 1125, the data acquisition of 1119 can change the frequency of the supply power applied to the motor 137 so that its speed of the motor substantially matches the corresponding speed defined by the virtual drive characteristic based on its actual (present) slope (a-actual). At 1127, the data acquisition of 1119 measures actual speed (S) of the motor. At 1128, the torque determined at 1123 and the speed determined at 1127 are recorded in vectors T(n) and S(n) in association with an index value I. At 1129, the control sequence of 1119 determines whether the iteration time (i.e., T-iteration) of the acquisition sequence for the present slope of the virtual drive characteristic is complete. If not, the iterative control sequence 1119 returns to 1121 and iteratively repeats. On the other hand, if the data acquisition of 1119 is determined to be complete at 1129, then the vector T(n) and S(n) describe the torque and speed functions versus time, corresponding to the last value of the slope, then the processing sequence 1130 is performed on the vector T(n) and S(n) obtained by the data acquisition of 1119 for the selected slope.

The extremum (Tmax and Tmin) present in the time sequence of torque (as vector T(n)) and the extremum (Smax and Smin) present in time sequence of speed (as vector Sn(n)) corresponding to the last control sequence of duration of time (T-iteration) can also be found directly in the time sequence as shown in FIG. 10A. These extremum can also be found in the graph “Torque versus RPM” illustrated, for example, in graph 905 of FIG. 9B (described above). Similar correspondence can be performed in the vector S(n) in relation of the maximum and minimum value of the speed Vmax and Vmin.

Continuing from the data acquisition of 1119 via reference link “A” from FIG. 11A to FIG. 11B, at 1133, the processing sequence 1130 may involve a fast Fourier transform (“FFT”) which can be performed on vector T(n) and S(n) on torque and speed determined during iterative control sequence of 1119 over “n” indexed samples during the iterations on time. This FFT produces amplitude and phase for the vectors versus frequency, which is also incremental. Thus, the FFT of T(n) provides Tₐ(frₙ) and Tₚₕ(frₙ), and the FFT of Sn(n) provides Sₐ(frₙ) and Sₚₕ(frₙ), while fr(n) represents the frequency, which has the same number of frequency value as time values in the vector T(n) and S(n).

At 1134, in the series “amplitude versus frequency” Ta(Frn) corresponding to torque, the processing sequence 1130 determines a maximum (e.g., peak) value of the amplitude corresponding its frequency Fr-Torque. It records this peak torque value as ΔT and its associated frequency as Fr-Torque.

At 1135, in the series “amplitude versus frequency” Sa(frn) corresponding to speed, the processing sequence 1130 determines a maximum (e.g., peak) amplitude corresponding to its frequency Fr-Speed and records this maximum speed value as ΔS and its associated frequency as Fr-Speed In implementations, additional filtering can be applied on the series representing T and S before the determination of the corresponding peaks at 1133 and/or 1134.

At 1136, the processing sequence 1130 determines a base period of the drill string assembly oscillation. In implementations, the base period of T(n) and S(n) can be determined from the frequencies Fr-Torque and Fr-Speed. For example, “K_base_period”=1/Fr-Torque+1/Fr-Speed. Also, using the time_step of 1121, the process 1130 can define the corresponding number of successive samples in T(n) and S(n) contained in a K_base_period.

At 1137, the processing sequence 1130 selects a multiple of the base periods determined at 1136, including a corresponding number of samples in the time sequence of T(n) and S(n). Referring to these series of samples “processed data set for torque” and “processed data set for speed,” at 1139 the processing sequence 1130 calculates an average value of torque and speed from the processed data sets of 1137. In 1143, the processing sequence 1130 records the last calculated standard deviation ΔT and ΔS in relation to slope of the virtual characteristic line slope α. The processing sequence 1130 terminates by storing ΔT, ΔS, “K_base_period” and α_{actual} in corresponding vector ΔT(k), ΔS(k), Period(k)and α(k), in which k in the recording index.

At 1145, the process 1100 increments “α-actual” as “α-actual” =“α-actual” +“α-inc” At 1146, if α-actual <α-end, then the range of a for potential value a is not yet fully covered, so that the iterative control sequence of 1119 iteratively continues, as indicated by linking reference B referring back to FIG. 11A.

Continuing process 1100 via reference link “C” from FIG. 11B to FIG. 11C, after exiting the iterative control sequence of 1119, at 1147 the process 1100 determines the optimum slope (α-opt) of the virtual drive characteristic in the range of slope scanned during control sequence 111. Such determination can be based on the linked vectors ΔT(k), ΔS(k) and α(k). More specifically, at 1148 the process 1100 can select a function of the slope of the virtual drive characteristic to be improved, as explained above. For example, this function may be one of the following functions (described above):

Osc-PowerApp(α)=K₁ ΔT(α) ΔS(α), (3)

Impedance(α)=IΔT(α)/ΔS(α)−αI, and (4)

Red Energy(α)=ΔT(α)²+K₂/K₁ ΔS(α)² (6)

At 1149, based on the selected function of the slope of the virtual drive characteristic determined at 1148, a vector Function(k) can filled for the available sets of data ΔT(k), ΔS(k) and α(k). For example, Function(K)=K1 ΔT(k) ΔS(k) as a general name corresponding top the choice of the function (2) selected in 1148. At 1151, an extremum of the Function(k) is determined. This extremum can be a maximum determined for the case of function (3), for example. Additionally, the extremum can be determined by finding a minimum such as with the function (4). Such a determination could use a loop along the value of the vector “Function(k)” to find the extremum value. In 1153, with an index value “j” corresponding the extremum, a selection can be made of the corresponding α(j-opt), which is the value of the slope of the virtual drive characteristic, such that aopt =α(j-opt). The main resonance period corresponding to the oscillation of the drill string (e.g., drill string 305) and bottom hole assembly (e.g., bottom hole assembly 306) can also be determined by selected the correspondence value in the vector Period(k) for the index j-opt. This can be called Main_Period=Period(j-opt)

At 1154, the process 1100 drives the motor based on the slope of the virtual drive characteristic determined by 1147 (i.e., α-opt). In embodiments, at 1155 a VFD is controlled by a controller (e.g., controller 139) based on the slope of the virtual drive characteristic, which is used to adjust the frequency of the power output by the VFD based on the actual torque measure, e.g., at top of the drill string assembly.

In 1156, when the time for new optimization cycle is reached, the process 1100 can prepare a next optimization cycle started at 1115. In implementations, the preparation for the next optimization cycle can include optimizing a pre-defined range for the slope of the virtual drive characteristic (α-range) and, and values for αlast accepted, αmin, and αend. For example, a range for the slope of the virtual drive characteristic can be defined by selecting αₒₚₜ the minimum or maximum of the range of α for the completed improvement cycle, then αrange is not modified. Otherwise, the new range may be limited as followed “α-range” =(“α-opt”+“α-last-accepted ”)/2. The next iteration loop will start with a new value of α-last-accepted which is set equal to α-opt. With such potential adaptation of αrange and α-last-accepted, the next iteration process for determining the parameter a may be performed with less cycles or more accuracy. A new optimization cycle can then iteratively begin at 1115, as indicated by linking reference D.

FIG. 12 shows a block diagram illustrating an example of a top drive system 115 and a rotary drilling system 303, according to an implementation. The top drive system 115 and the rotary drilling system 303 can be the same or similar to those previously described herein. The top drive system 115 rotates the rotary drilling system, which includes a drill string 305 and a bottom hole assembly 306, as well as the motor rotor with its inertia 1210. The top drive system 115 includes a motor 137, which can be the same or similar as those previously described herein and an optional gearbox (not shown). The drill string 305 can be represented as comprising a torsional resonator due its torsional rigidity allowing elastic torsion of the drill string 305 under torque and associate with to multiple rotational inertia (e.g., the bottom hole assembly 306 and the motor inertia 1210, as well as other distributed inertias (not shown) that may be included in the rotary drilling system 303. The rotary drilling system 303 associated with the motor rotor 1210 acts as a rotary resonator 1220. This resonator may be excited by the torsional oscillation appearing during rotation when torsional excitation may be present. The torsional excitation may be generated by the variation of friction 1215 between the drill string 305 and/or bottom hole assembly 306 and a borehole, including the bit cutting effect and the friction along the wellbore. The principal inertia affecting resonance is the bottom hole assembly 306 acting as a rigid flywheel, the distributed inertia of the drill-pipe section, and the motor rotor 1210 which includes rotational inertia, which can be affected by an optional gearbox of the top drive system 115. Inertia present at the motor 137 can affect some resonating modes of the drill string 305 and/or the bottom hole assembly 306.

In implementations of the top drive system 115 consistent with aspect of the present disclosure, a virtual motor-rotor inertia may be represented by the following relation:

T=βυ∂Ω/∂t (7)
wherein:
βv is the virtual inertia of the motor,
∂Ω/∂t is the rotational acceleration of the drill string assembly, and
T is the torque that occurs to rotate the virtual motor-rotor inertia βv in the presence of the rotational acceleration.

With regard virtual inertia of the motor βv, the variation of rotational speed can be measured (e.g., by sensors 135) and fed a control system (e.g., controller 139). The control system can determine the corresponding torque due to the virtual inertia (βv) of the motor by the applying the formula (7). For example, with reference to FIGS. 9A-9C, the effect of the virtual inertia of the motor can generate difference of torque between the two sides of the following motor-rotor inertia algorithm:

T_{EM}=Tᵢₙ₋ₗᵢₙₑ−(βυ+βr) ∂Ω/∂t (8)
wherein:
T_{EM} is the electromagnetic torque generated at the motor,
Tᵢₙ₋ₗᵢₙₑ is the torque measured by the in-line sensor (between the motor 137 and the drill-sting 305), and
βυ is the motor rotor virtual inertia, and βr the motor real inertia.

For example, a rotor of the motor 137 may be considered as the squirrel cage supporting the electromagnetic torque, while the rotor lamination can be considered the motor inertia 1210. The electromagnetic torque generated by the stator 1212 onto the squirrel cage may be considered as a system without inertia turning the rotor due the presence of the electromagnetic torque. The virtual inertia of the motor can be represented, for example, as an additional flywheel added to the rotor (e.g., a heavier lamination stack). To simulate the presence of the additional virtual inertia, the drive torque (electromagnetic torque generated by the stator 1212) can be reduced in comparison to the in-line torque by the following algorithm:

T_{EM}_{_}_{eq}=βv ∂Ω/∂t (9)

In an implementation, the virtual inertia of the motor can be adapted so that the resonance frequencies along the drill string 305 and bottom hole assembly 306 are modified so that the effect of the resonance is minimized on the torque and/or speed oscillation recorded versus time.

FIG. 12 also depicts a model of the resonance within the top drive system 115. The drill string 305 can substantially function as a torsional resonator due to a combination of its inertia and rigidity. Some of the inertia may be distributed (as the effect of the inertia of the drill string 305) or lumped as the effect of the bottom hole assembly 306 and the motor rotor inertia 1210 of the motor 137. When a source of torsional excitation (e.g., stick-slip) occurs, rotational variation may be created with potential effect on torque and speed variations. Variation in friction along, a borehole and at a bit of the bottom hole assembly 306 can generate the torsional excitation at the wall of the borehole or at the bit. A stable resonating pattern may-be generated by a torsional wave 1205 reflecting upwards and downwards along the drill string 305. Reflection of the torsional wave 1205 may occur, for example, at top of the drill string 305 as well as in the wellbore due to with the drill string 305. Highest and lowest resonance amplitudes of the torsional wave 125 may occur when the wave length corresponds to certain proportion of the length L of the drill-string assembly (e.g., the drill string 305 and the bottom hole assembly 306) and a potential reflector.

In accordance with aspects of the present disclosure, the control system can control the virtual inertia of motor to change the resonance frequency of the rotary drilling system involving the top drive system 115, the drill-string 305 and bottom hole assembly 306. As described herein, the amplitude of the torsional wave 1205 can be reduced by controlling the resonance of the rotary drilling system so that the excitation frequency does not match any resonance frequency of the rotary drilling system. Accordingly, the virtual inertia of the motor can be tuned to operate the system at a lowest resonance amplitude.

FIGS. 13A-D illustrate a flow diagram of a process determining a virtual motor inertia (βv) of a motor (e.g., motor 137) combined with drive electronics actuating a rotary drilling system (e.g., rotary drilling system 303), according to an implementation. At 1301 of FIG. 13A, the process 1300 determines a range of the virtual motor inertia. In implementations, the range includes β-minimum and β-maximum, as percentage of virtual motor inertia over K steps. As used below, β-actual can be equal to β-minimum. At 1302, the processes 1300 selects a value of the slope (α) of a virtual drive characteristic as well as the nominal operating point (as in 110 of process 1100 in FIG. 11A), which can be determined as previously described herein. As also described previously, the slope of the virtual drive characteristic can pass substantially through the selected operating point (see, e.g., FIG. 11A, 1107) with slope α-opt see, e.g., FIG. 11, 1155.)

At 1303, the process 1300 determines a duration of acquisition (K) for the individual acquisition sequences. For example, the duration can be a number K of base periods which can be determined either from K_base_period, as previously described at step 1136 of process 1100 in FIG. 11B or from Main-period as previously described at step 1153 of process 1100 in FIG. 11C. In implementations, the number K may be between 2 to 10. However, the value is not limited to that range. For example, in some implementations, for example, the value of K may range from 1 to 25. At 1304, a “time_step” for the individual acquisition sequences of the virtual motor inertia can be determined. The time_step may be obtained as K base period/ N_step, wherein N_step can be chosen so that time_step is similar or shorter to of half-period of the shortest period of a VFD output signal (to avoid aliasing). For example, the time_step may be in the range of 5 to 20 millisecond. At 1305, the process 1300 can select a predefined number “m” iterations for the an iterative loop on the value of the virtual inertia βv-actual. At 1306, the initial value of virtual motor inertia (as βv-actual) is selected for a first loop of the iterative process.

Continuing the process 1300 via reference link “A” from FIG. 13A to FIG. 13B, for the m steps, the process 1308 can iteratively optimize the virtual motor inertia by performing a loop from βv-minimum and βv-maximum in the “m” iterations to determine the effect of virtual motor inertia on the rotation versus time. For every iteration, the process 1308 can include an acquisition loop 1309 to obtain sufficient data of torque and speed versus time, followed by processing sequence 1319. For the values of “m” of the loop 1308, the acquisition loop 1309 can be performed over “time-step” iteration that corresponds to time increment. The acquisition loop 1309 can acquire the value of torque and speed, while applying the virtual drive characteristic selected at 1302 and the actual (e.g., present) virtual motor inertia (βv-actual). Then within the process 1308, the behavior of the rotating conditions are determined by determining speed (S) and torque (T) and period corresponding to the βv-actual. More specifically, within the acquisition loop 1309, for the actual value of virtual inertia βv-actual, at 1309-2, continuous frequency control of the motor (e.g., motor 137) can be performed. At 1309-03, the acquisition loop 1309 measures torque and acceleration of the drill string assembly (e.g., drill string 305 and bottom hole assembly 306). At 1309-4, the acquisition loop 1309 determines the effect of the virtual motor inertia (βv-actual) based, for example, on formula (7). At 1309-5, the acquisition loop 1309 determines the corrected drive torque (T_{EM}) based on formula (8) which is a corrected torque with respect to the virtual drive characteristic selected at 1302. At 1309-6, the acquisition loop 1309 changes the frequency of the power output to the motor (e.g., AC power 311) based on the corrected drive torque associated the virtual drive characteristic and the set of motor characteristics (such as shown in FIG. 7). At 1309-7, the process 1308 measures the speed of the drill string assembly. At 1309-8, the acquisition loop 1309 stores the speed measured at 1309-7 and the torque determined at 1309-5 in vectors S(n) and T(n). At 1309-9, the acquisition loop 1309 determines whether a time of acquisition is complete. If the time of acquisition is not complete, then the process 1308 iteratively returns to 1309-2 and continues. If the time of acquisition is complete, then the acquisition loop 1309 ends, and the process 1308 proceeds to the processing 1319 related to the acquisition loop of FIG. 13C via reference link “B”. The processing 1319 involves several steps from 1310 to 1316.

At 1310, the process 1308 performs Fast Fourier Transforms (“FFT”) on the records T(n) and T(n) to determine Tₐ(frₙ), Tₚₕ(fₙ), Sₐ(frₙ), Sₚₕ(frₙ), which can be performed in the same or similar manner to that previously described herein (see, e.g., FIG. 11B, 1133). At 1311, the loop 1308 determines the maximum amplitude in the vector “torque versus Frequency Ta(frₙ)”, records this maximum as ΔT and its associated frequency as “Fr-Torque” which can be performed in the same or similar manner to that previously described herein (see, e.g., FIG. 11B, 1134). At 1312, the loop 1308 determines the maximum amplitude in the vector “Speed vs. Frequency Sₐ(frₙ))”and records this maximum as ΔS and its associated frequency as “Fr-Speed”, which can be performed in the same or similar manner to that previously described herein. (See, e.g., FIG. 11B, 1135.) At 1313, the loop 1308 determines the base period for the records T(fr) and S(fr) (For example, “K_base_period”=1/Fr-Torque+1/Fr-Speed) and calculates the global corresponding K_base_period, which can be performed in the same or similar manner to that previously described herein (see, e.g., FIG. 11B, 1136). At 1314, the processing sequence 1319 of the loop 1308, in a time sequence of torque (T(n)) and speed (S(n)), selects a multiple of the system period, and a corresponding successive number of samples in T(n) and S(n), which can be referred to as “processed data set, (Torque(i) and Speed(i))”, 1314 can be performed in the same or similar manner to that previously described herein (see, e.g., FIG. 11B, 1137). At 1315, the loop 1308, from the individual processed data sets, calculates an average speed and average torque, which can be performed in the same or similar manner to that previously described herein (see, e.g., FIG. 11B, 1139). For example, ΔT and ΔS can be calculated as standard deviations based on samples T(n) and S(n) of the processed data set. At 1316, the loop 1308 records ΔT, ΔS and period K_base_period versus the actual value of the virtual motor inertia in vectors ΔTorque(k), ΔSpeed(k), period (k), βv(k), which can be performed in the same or similar manner to that previously described herein (see, e.g., FIG. 11B, 1143) and conclude the processing 1319.

At 1317, the optimization process of 1308 increments the virtual motor inertia, which can be performed in the same or similar manner to that previously described herein. (See, e.g., FIG. 11B, 1145). At 1318, the loop 1308 determines whether β-actual incremented at 1317 is less than β-end. If not, the process 1300 iteratively returns to 1309 via linking reference C. 1318 can be performed in the same or similar manner to that previously described herein (see, e.g., FIG. 11B, 1146).

If the β-actual is greater than or equal to β-end, following linking reference “D” to FIG. 13D. At 1320 the process 1300 determines the optimum value of the virtual motor inertia (as βv-opt) by the steps 1322 to 1328. At 1322, the process 1320 select the function to optimize to determine the optimum value of the virtual motor inertia such as:

Osc-PowerApp(βv)=K₁ ΔT(βv) ΔS(βv), (3)

Reduced_Energy(62 v)=ΔT(βv)²+K2/K1 ΔS(βv)², or (6)

At 1324, based on the selected function (of the virtual motor inertia) determined at 1322 a vector Function(k) can be filled for the available sets of data ΔT(k), ΔS(k) and βv (k). For example, Function(K)=K1 ΔT(k) ΔS(k) as a general name corresponding top the choice of the function (3) selected in 1322.

At 1326, an extremum of the Function(k) is determined. This extremum can be a minimum determined for the case of function (3), for example. Additionally, the extremum can be determined by finding a minimum such as with the function ΔT(βv) or ΔS(βv). Such a determination could use a loop along the value of the vector “Function(k)” to find the extremum value.

In 1328, with an index value “j” corresponding the extremum, a selection can be made of the corresponding βv(j-opt), which is the optimized value of virtual motor inertia, such that βv-opt=βv(j-opt). The main resonance period corresponding to the oscillation of the rotary drilling system can also be determined by selected the correspondence value in the vector Period(k) for the index j-opt. This can be called Main-Period=Period(jₒₚₜ)

At 1330, the process 1300 drives the motor based on the virtual drive characteristic (defined in 1302) and with virtual motor inertia characteristic determined by the process 1320 (i.e., βv-opt). In an embodiments, at 1332, a VFD (e.g., VFD 309) is controlled by a controller (e.g., controller 139) based on optimized virtual motor inertia (as selected in 1328) and the slope of the virtual drive characteristic (selected in 1302), which is used to adjust the frequency of the power output by the VFD based on the actual torque measure, e.g., at top of the drill string assembly and the rotation acceleration of the drill-string.

In 1334, when the time for new optimization is reached, the process 1300 can prepare a next optimization cycle started at 1309. In implementations, the preparation for the next optimization cycle can include optimizing a pre-defined range for the motor virtual inertia (βv-range) and, and values for βv-last accepted, βv-min, and βv-end. For example, a range for the motor virtual inertia can be defined by selecting βv-opt the minimum or maximum of the range of βv for the completed improvement cycle, then βv-range is not modified. Otherwise, the new range may be limited as followed “βv-range”=(“βv-opt”+“βv-last accepted”)/2. The next iteration loop will start with a new value of βv-last accepted which is set equal to “f 3 v-opt.” With such potential adaptation of βv-range and βv-last accepted, the next iteration process for determining the parameter βv may be performed with less cycles or more accuracy. A new optimization cycle can iteratively begin at 1309, as indicated by linking reference D.

For example, the process 1300 can iteratively loop on the set of value of ΔSpeed(k) and ΔTorque(k) to determine a minimum value of the virtual motor inertia. At 1324, the process selects the “k” corresponding to the minimum for the function to minimize torque, speed and/or one of the functions (3), and (6), which combine torque and speed. At 1326, determines the value of βv-opt, as well as the period of the resonating process. In some implementations, the minimum oscillation may be determined by using other functions related to the torsional behavior of the drill string. In some case, this function can be a detailed model of the mechanical construction of the drill string including also the interaction of the drill string with the wellbore. Some models may include the trajectory of the wellbore to improve the description of the interaction of the drill-sting and the wellbore. Other improved models may include the model of the cutting structures such as the drill-bit and the reamers. In another embodiment, the minimum of the following algorithm over the whole set of data obtained by the previous iterative loop 1310 to 1326 may be based on such functions:

\sqrt{ΔSpeed(k)²+K3 ΔTorque(k)²} (10)

The parameter K3 can depend on the torsional rigidity and the inertia of the drill string, which can be estimated based on a model of the drill string, such as described above with regard to FIG. 12, for example. It is understand that such model can also be a detailed model of the drill string with its interaction with the borehole. The determination process 1320 determines the optimum values for βv-opt that minimizes the amplitude of the potential resonance of the rotating system that includes the drill-string and BHA. This process 1320 also determines the main resonance period (Main period) of that rotary system at 1328

The processes 1300 allows implementations consistent with the present disclosure to tune the operation of an motor driven by the VFD, so that a drill string impedance is matched to the impedance of the drive system, which allows smooth drive of the drill string. Further, the process 1300 allows and (ii) with the virtual inertia of the rotor, the effect of the resonance is minimized.

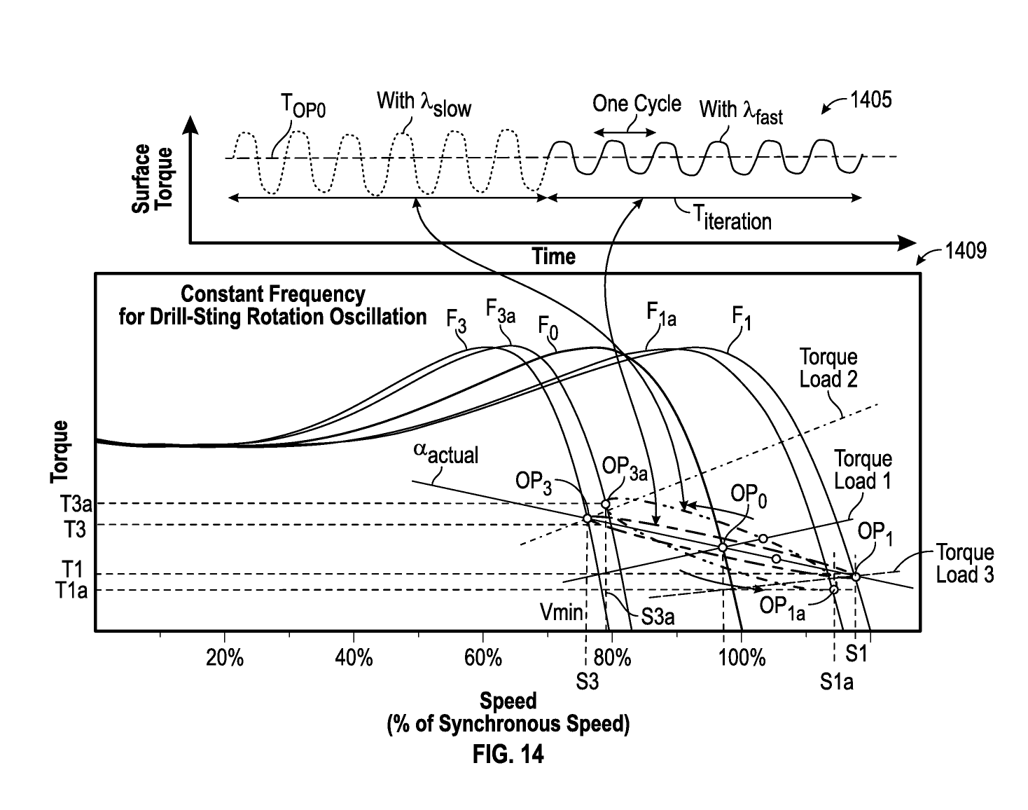

FIG. 14 shows illustrating a graph 1409 of a of the reference function for a motor driving a drill string, according to an implementation. More specifically, FIG. 14 illustrates the response of the motor (e.g., motor 137) driven by a variable frequency supply power (e.g., AC power 311 from VFD 309) using different adjustment rates (λ). The value of the adjustment rate corresponds to the capability of the system change the frequency of the supply power. Such parameter may be defined as:

$$λ = \frac{\frac{\partial F}{\partial t}}{F} \qquad ( 11 )$$

A high value of the adjustment rate allows the system to quickly adjust the frequency supply power. In such case, the output is continuously close the line representing the virtual drive characteristic, as shown in FIG. 14. Notably, with a low value of the adjustment rate, the VFD may not adjust fast enough and any VFD output frequency setting may allow the system to define an operating point (e.g., OP3a and OP1a), which are not on the virtual drive characteristic. The low adjustment rate may not provide the ideal response in presence of variation of the rotational-conditions, especially if the frequency of this variation is close the resonance frequency of the rotary drilling system. When operating with a fast adjustment rate, the torque variation may be lower, as shown in FIG. 14, as the system operates close the theoretical virtual drive characteristic. These elements may improve the reliability of the system and, in particular, the drill string.

When operating with fast adjustment rate, the width of the loop (e.g., as depicted in FIG. 9B) on the graph torque versus speed is narrower, as shown in FIG. 14. Also with fast adjustment rate, the extremities of that loop can be characterized by operating point OP3 and OP1 which are nearly on the extreme torque-loads 1 and 3, as shown in FIG. 14. And the output frequency varies between F1 and F3. When operating with a slow adjustment rate, the extremity of the loop are moving away from the virtual drive characteristic, as OP1a and OP3a in FIG. 14). The output frequency varies over a smaller range, e.g., between value F1a and F3a in FIG. 14.

The use of a virtual drive characteristic associated with virtual rotor inertia allows to reduce the torque variation (ΔT=T3a−T1a), while increasing the speed variation (ΔS=S3a−S1a). Over one cycle of drill string rotation oscillation, the frequency of VFD power output would vary from F1a to F3a, while the mean value is F0 (which is imposed by the pre-defined nominal operating point). If the drill string rotation oscillation period is T-osc (which corresponds to the “drill string rotation oscillation” frequency F-osc=1/T-osc), a critical adjustment rate can be estimated

λc=(F1a−F3a)/(T-osc F0) (12)

With such adjustment rate λc, a controller (e.g., controller 13) and a VFD (e.g., VFD 309) can adjust the frequency of AC power output to allow to match the behavior of the drill-string in rotation combined with oscillation at frequency F-osc while turning at the average speed S0 defined by the nominal operating point P0, requiring a nominal drive frequency F0 at the power output 311.

This can be re-written in term of critical frequency for a given adjustment rate, knowing that Fr=1/T where T is the period of the oscillation.

Fr-osc=λc F0/(F1a−F3a) (13)

Fr-osc=K-motor S0 λc/K-motor (V1−V3) (14)

Fr-osc ΔV_{osc}=λc S0 (15)

wherein:

Fr-osc is the frequency of the drill oscillation,

ΔV-osc is the total amplitude of the drill oscillation,

S0 is the nominal operating speed of the drill-string, and

λc is the selected adjustment rate for the frequency of the VFD power.

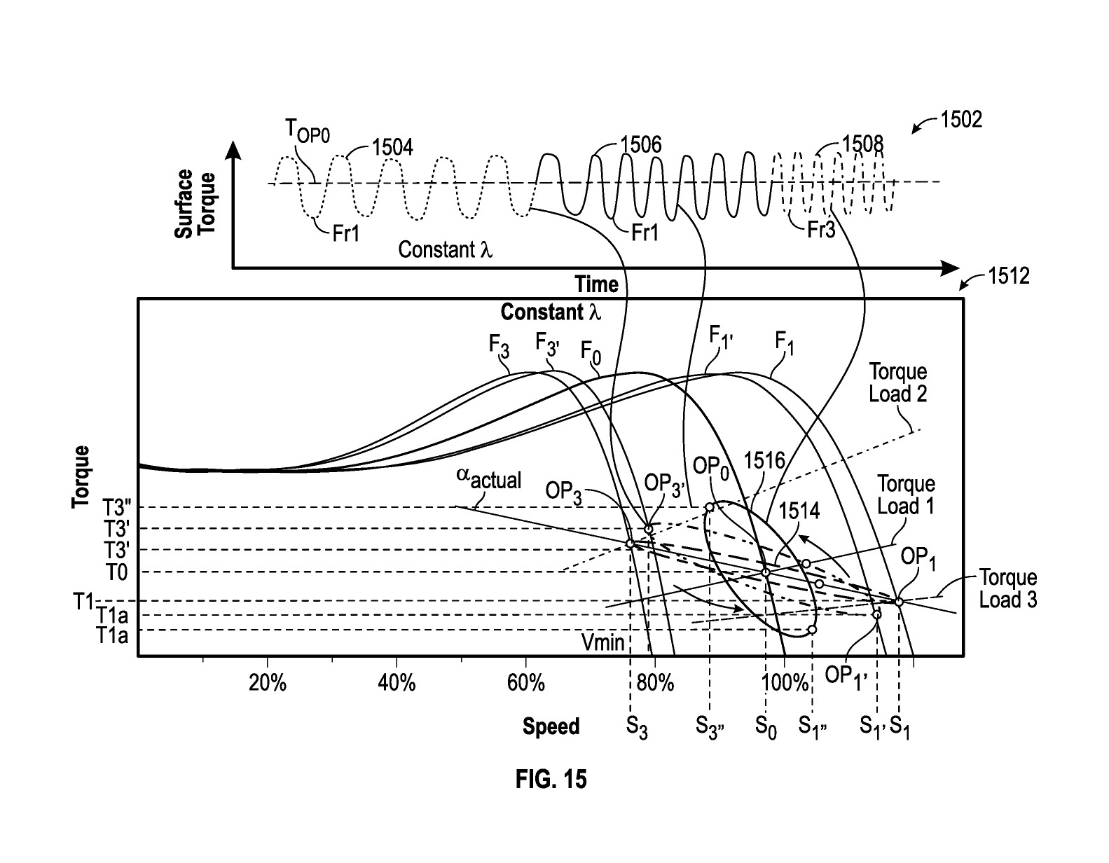

With the selected adjustment rate λc, the frequency of the power output (e.g., supply power 311) of VFD can be continuously adjusted by the controller 139 during a cycle of oscillation of drill-string operating at a defined nominal condition (speed) and having a defined oscillation frequency and amplitude. Otherwise, the frequency of the power output may not fully follow the needed change for the VFD power output 311. This behavior is depicted in FIG. 15, which illustrates an example of a response for a controlled motor versus different excitation frequencies of the rotary drilling system, according to an implementation. The graph 1502 depicts the time variation of the surface torque (such as measured by a sensor 135), while the graph 1512 represents the same information as torque versus speed at the top-drive motor. When oscillation occurs at low frequency as shown by 1504 (at oscillation frequency Fr1), the control system manages that the motor setting follows nearly the virtual drive characteristics as shown by the narrow ellipse 1514. However, when the drill-string is excited at higher frequencies such as 1508 (or oscillation frequency Fr3 for drill-string), the control systems may not ensure fast adjustment of the frequency of power output and the motor may not be able to follow accurately the virtual drive characteristic: as an example, this is shown by the path 1516.

It should be noted that the FIGS. 14 and 15 represent similar behaviors of the motor response “torque versus speed.” More specifically, FIG. 14 depicts the effect of modifying the VFD adjustment rate while the frequency of the drill-string oscillation is kept constant. FIG. 15 depicts the effect of the modifying the frequency of the drill-string oscillation while the VFD adjustment rate is kept constant.

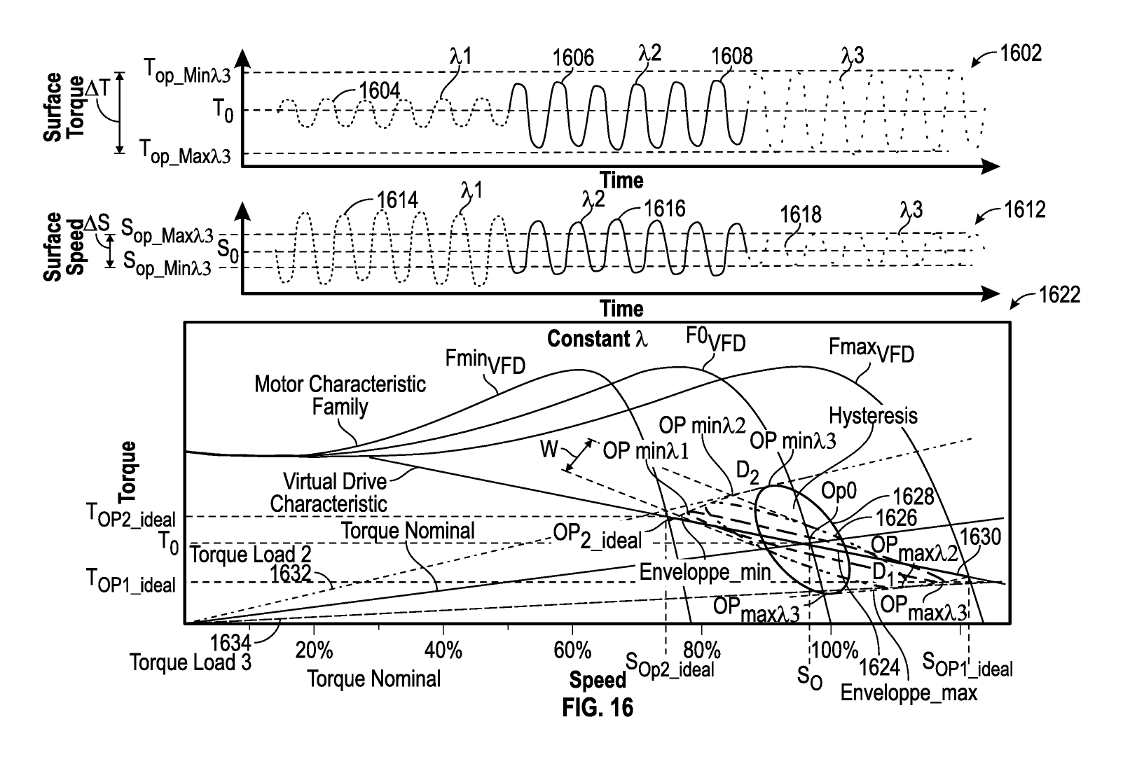

FIG. 16 shows graphs illustrating an example of a response for a controlled motor versus different “adjustment-rate” under a steady excitation frequency of the rotary drilling system, according to an implementation. More specifically, FIG. 16 illustrates the effect of modification of the adjustment rate as another embodiment, while the oscillation frequency of the drill-string is mainly kept constant. The graph 1602 represents the surface torque at the drill-string versus time, as measured by a sensor 135. The graph 1612 represents the surface speed at the top of drill-string versus time. The graph 1622 represents the same data as torque versus speed for the output of the motor 137. In this graph, multiple operating points (such OP0, OP2_ideal, OP1_ideal). Each of these points is characterized by a speed (such as S0, S OP2_ideal) and a corresponding torque (T0, TOP₂ ideal).

The graphs 1602, 1612, and 1622 of FIG. 16 represents data corresponding to three different periods where a controller (e.g., controller 139) controls a VFD (e.g., VFD 309) with three different adjustment rates (λ1, λ2, λ3) and the same virtual drive characteristics. The data for these three periods of graphs 1602 and 1612 appear as three independent elliptical-looking paths in graph 1622, with the following matching: data 1604, 1614 into 1624; data 1606, 1616 into 1626; and data 1608, 1618 into 1628. A matching error between the ideal case (the motor follows at any moment the virtual drive characteristic as shown in 1630) and the real case (the motor follows an ellipse 1628) can be defined. A possible definition of such error can be:

Match_Error=(SOP1_ideal−SOP2_ideal)/(Sop Max_λ−Sop min_λ)−1, (16)
wherein:
SOP1_ideal is the maximum theoretical motor speed during one oscillation cycle when the controller 139 performs the control of the VFD 309 with the current virtual drive characteristic and the rate of adjustment λ is infinite;
SOP2_ideal is the minimum theoretical motor speed during one oscillation cycle when the controller 139 performs the control of the VFD 309 with the current virtual drive characteristic and the rate of adjustment λ is infinite;
Sop Max_λ is the maximum real motor speed during one oscillation cycle when the controller 139 performs the control of the VFD 309 with the current virtual drive characteristic and the rate of adjustment λ is selected to the desired value; and
Sop min_λ1 is the minimum real motor speed during one oscillation cycle when the controller 139 performs the control of the VFD 309 with the current virtual drive characteristic and the rate of adjustment λ is selected to the desired value.

Other definitions of the match_error may be proposed. As another embodiment, the match_error can be determined by the surface defined by the “ellipse” performed during one cycle of oscillation for the drill-string (as 1628 in FIG. 16). The match_error would be “null” when the selected adjustment rate λ is infinite as the ellipse become the portion of the straight line 1630 superpose on the virtual drive characteristic. Such match_error can be a type of hysteresis.

The operating points (Sop Max_λ and Sop min_λ) corresponding to operation with a defined adjustment rate, can be determined from the speed measurements performed by the sensor 135: example of such measurements versus time are shown in FIG. 16 in graph 1612 for the case of λ3, Sop Max_λ would correspond to the maximum speed of the time record, which can be also determined via FFT as previously explained. Also, Sop min_λ would correspond to the minimum speed of the time record, which can be also determined after FFT as previously explained. However, the ideal operating points (OP2_ideal and OP1_ideal), corresponding to operation with infinite adjustment rate can may be limited to being estimated as normally the adjustment rate will not (may not) be set the infinite (maximum) value. For such estimation, the “envelope” of the operating points for various adjustment rate will be determined and extrapolated to the virtual drive characteristic to estimate OP2_ideal and OP1_ideal. Such “envelope” curves can be obtained when the rotating system (e.g., rotating drilling system 303) including the drill-string (e.g., drill string 305), the bottom hole assembly (bottom hole assembly 306) and the motor rotor inertia (e.g., motor rotor inertia 1210) has been rotated by the motor (e.g., motor 137) when the controller has been applying different adjustment rates λ, allowing the definition of multiple ellipses (such as 1624, 1626 and 1628) in the graph 1622 of torque versus speed.

Additionally, in another implementation of a method to obtain the ideal operating points (OP2_ideal and OP1_ideal) may be used. Such method may be based on linear torque loads (such as 1632 and 1634), which may pass by the origin of the graph. These substantially linear torque load would also passes by some points of the ellipse which characterized the motor operation with the current adjustment rate k. As example, the points OP Max_λ and OP Min_λ of ellipse 1628. These points may be estimated from the graphs 1602 (Top Max_ and Top Min_λ) and 1612 (Sop Max_λ and Sop Min_λ)

Other definitions of match error could involve the torque and speed data between the ideal operating points and real operating points. One potential definition of such error would be based on the sum of distance D1+D2 between these operating points as shown in FIG. 16.

$$Match\_error = ( D 2 max + D 1 max ) - \sqrt{{( Top min λ 3 - Top {2}_{ideal} )}^{2} + {( Sop min λ 3 - Sop {2}_{ideal} )}^{2}} - \sqrt{{( Top max λ 3 - Top {1}_{ideal} )}^{2} + {( Sop max λ 3 - Sop {1}_{ideal} )}^{2}} \qquad ( 17 )$$

Where D2max and D1max would be the corresponding distance when the elliptical path is aligned onto the motor characteristic F0 when working in open loop. Another definition of the match_error can be proposed based on the mean of the positioning error for all the points between the elliptical path 1628 and the theoretical straight path 1630, while having defined a single translation pattern from the ellipse 1628 to the theoretical straight path 1630.

With most of the proposed definition of the match_error, the value varies from zero (0) as minimum error to large value when the separation between the ellipses (e.g., 1628) is well marked versus the ideal range of setting (e.g., 1630).

Additionally, in another implementation of the match_error may be normalized in relation with the oscillation power of the rotary system. A possible normalization may be as followed:

Match_error_normalized=k1 Match_error ΔT ΔS (18)
wherein:
K1 is a coefficient to insure the normalization as oscillation power, and
ΔT ΔS characterized the rotary oscillation as defined in relation with the FIGS. 9B, 10A and 16 (in graph 1602 and 1612).

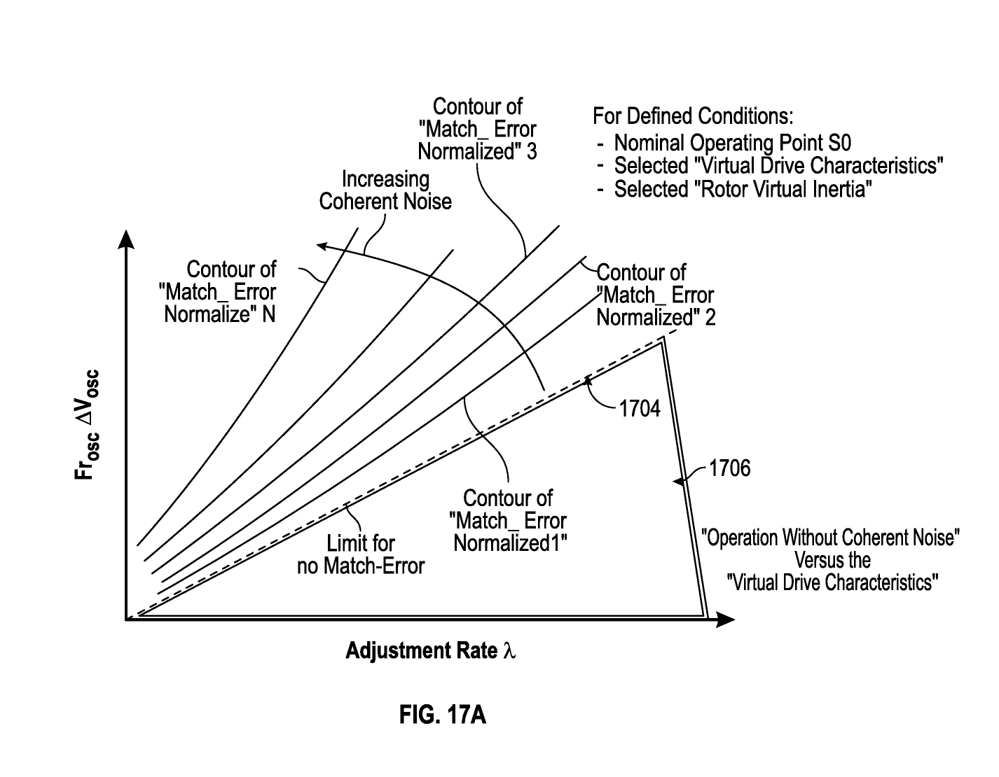

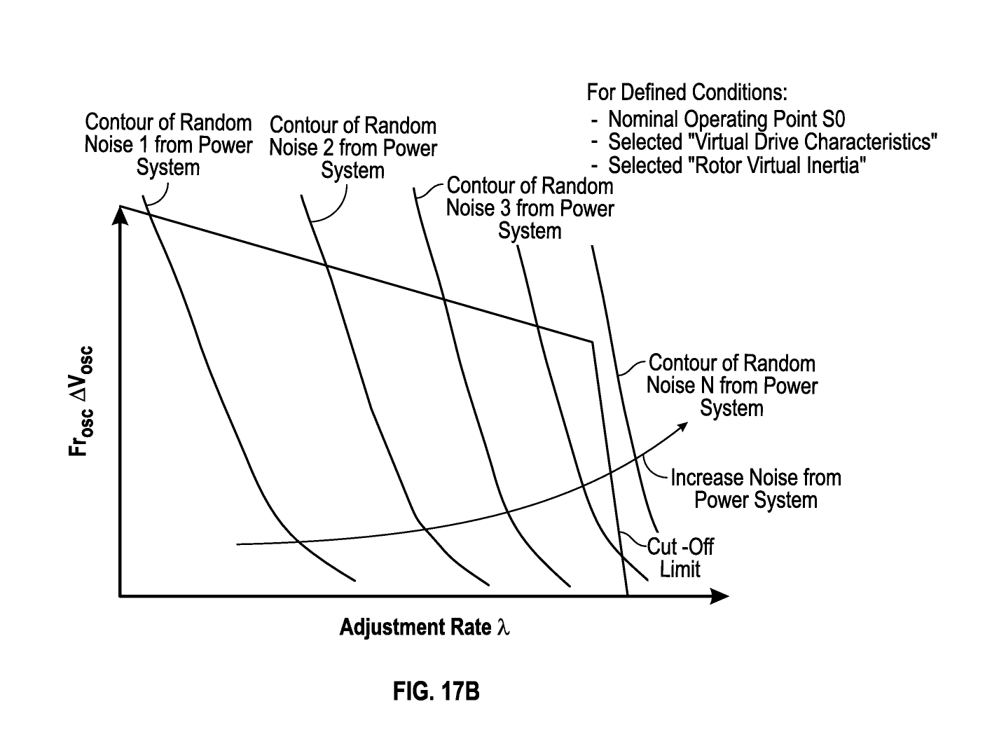

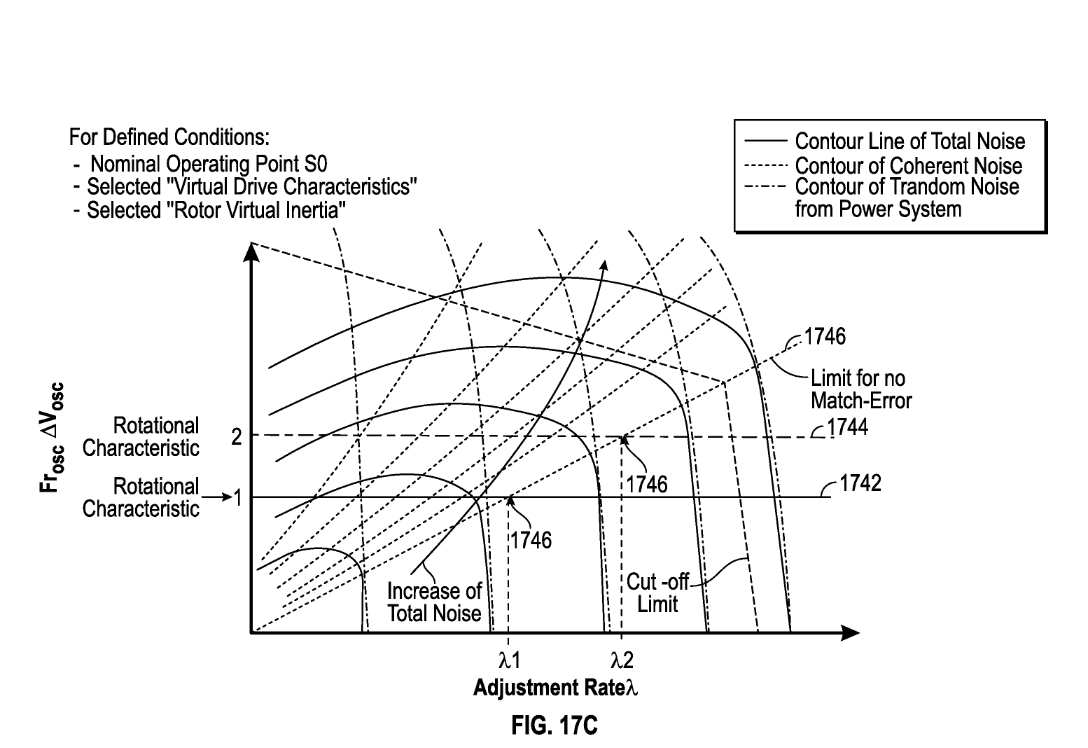

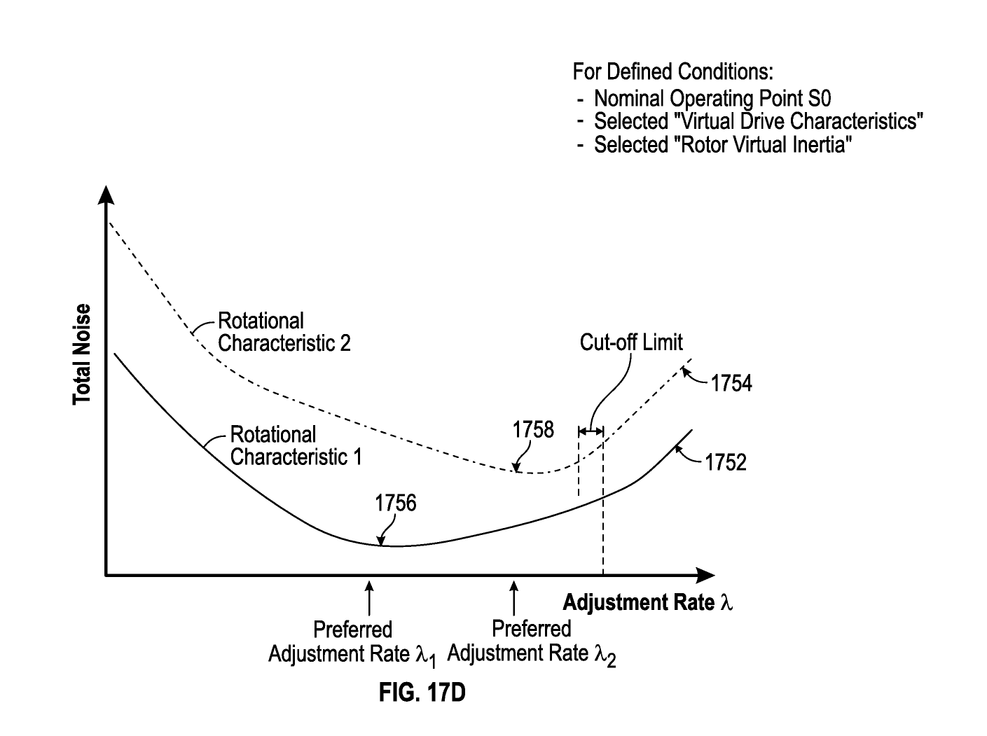

In implementations, the match error normalized may be minimized so that the rotating system operates close to the “virtual drive characteristics”. When considering the formula 15, the match_error_normalized can be kept to a minimum (in theory “0”) as long as Fr-osc ΔVosc<λc S0. However, when (Fr-osc ΔVosc−λc S0>0), the match error normalized increases. This is shown in the graph of FIG. 17A which represents the match_error_normalized as contour line of constant value in the 2D space defined by the “adjustment rate λ” as X-axis and “oscillation characteristic” of the drill string (defined by Fr-osc ΔVosc) as Y-axis of the graph. The formula 15 defines the equation of the line 1704. The area 1706 represents the zone of no error/deformation. Such graph is defined for specific conditions such as (but not restricted to) a defined operating point (T0, S0), a selected virtual drive characteristic and a selected rotor virtual inertia. The match_error_normalized can be renamed as “coherent noise”, as it is a deformation of the desired objective (to follow the virtual drive characteristic” as 1630). Such deformation is coherent with the process in such a way that for a defined situation, the deformation is coherent.

A fast adjustment rate requires the proper high performance for the whole system (e.g., FIG. 3, sensors 135, data acquisition unit 315, controller 139, driver unit 317 and IGBT 319 which control the AC power 311 for the top drive system 115). If one or some of these elements are not capable of sustaining the fast adjustment process, the system may not be able to generate the required frequency for the supply power at the proper timing (e.g., due to limits of the IGBT 319). This may result in an improper torque across the motor, which could degrade the function of the system. Noise is induced in the rotary system by these effects of the power system. Such noises may be characterized of “random noise,” as they are not correlated/ coherent to the drive process. The trend of this random noise is illustrated in FIG. 17B by contour lines of “constant value noise” in the same axes in 17 A. Such noise also generates perturbation in the drive system, not allowing the perfect operating conditions.

For given operating potential conditions, the total noise based on the random noise defined in FIG. 17B may be added to the coherent noise as defined in FIG. 17A. This total noise can also be displayed as contour line of constant value in a FIG. 17C, using the same axes as in FIGS. 17A and 17B. Furthermore, the control system and power system are limited in their maximum capabilities for adjustments so that the operating range is limited by cut-off capabilities. These cut-off limits are also illustrated in FIG. 17C.

FIG. 17C also illustrates the case of rotational characteristic 1 and rotational characteristic 2 on the Y-axis. For each of these rotational characteristics, the total noise can be determined in relation to the adjustment rate following the lines 1742 and 1744. These noises can be ported in the graph 17D. The line 1752 passes by a minimum at 1756 and nearly corresponding to the value of adjustment rate λ1 as defined in FIG. 17C. The line 1754 passes by a minimum at 1758 and nearly corresponding to the value of adjustment rate λ2 as defined FIG. 17C. When observing the FIG. 17C, it can be noted that λ1 and λ2 correspond to the crossings 1746 and 1748 between the “limit for no match_error 1746 and the lines 1744 and 1742 corresponding to a given rotational characteristic. If the rotary drilling system is affected by a condition of rotary oscillation (defined by Fr_{-osc} ΔV_{osc}), then the minimum (i.e. 1756) as displayed in FIG. 17D corresponding to the crossing of the line 1742 with the “limit for no Match error (1746). In an implementation, the adjustment rate can be selected versus oscillation characteristic (Fr_{-osc ΔV}_{osc}) of the rotary drilling system and the rotational speed in accordance with formula 15. There may be little, if any, benefit to select a higher value for the adjustment rate, as random noise will be introduced by the power system. There would also be little, if any, benefit to select a lower value as coherent noise would be introduced. The minimization of the total noise may have to include the condition involving multiple rotational characteristics. Such situation may occur when secondary resonance may be present along the rotary system involving the drill-string or when the amplitude of oscillation may vary versus time. It is necessary to minimize the total error induced by simultaneous sources of rotation oscillation.

FIGS. 18A-C show a flow diagram illustrating a process 1800 for determining an adjustment rate (λ), according to an implementation. At 1801, the process 1800 determines a range of the adjustment rate, which can be performed in a similar manner to that previously described (see, e.g., FIG. 13A, 1301). In implementations, the range is defined by λ-minimum and λ-maximum. λ-minimum can be defined in accordance with a drill string resonance frequency in relation to a variation of rotational speed typically recorded for that drilling string. maximum may be determined in accordance to the system (e.g., top drive system 115). As used below, λ-actual can initially be equal to λ-minimum. Also select the definition of the “Match_error” (e.g., formulae 16 and 17) to allow the determination of the “Match_error optimized” (formula 18).

At 1802, the processes 1800 selects a virtual drive characteristic having a slope (α) and virtual inertia (βv), which can be performed in a similar manner to that previously described (see, e.g., FIG. 13A, 1302). At 1803, the process 1800 determines a duration of acquisition (K) for an acquisition sequence, which can be performed in a similar manner to that previously described (see, e.g., FIG. 13A, 1303). The duration of acquisition can be a number of base periods, as previously described herein. (See, e.g., FIG. 11, 1156). For example, the duration of acquisition can be a value be between 2 to 10. However, the value is not limited to that range. In some implementations, for example, the value may range from 1 to 25.

At 1804, a “K time step” for the individual acquisition sequences can be determined as previously described herein (see, e.g., FIG. 13A, 1304). For example, K_time step may be obtained as “K base_period”/N_step, wherein N_step can be chosen so that time step is similar to of half-period of the shortest period of a VFD output signal. In implementations, the K_time_step can be in the range of 5 to 20 milliseconds. At 1805 a predefined number “m” iterations (e.g., “loop-time”) can be selected in a similar manner to that previously described (see, e.g., FIG. 13A, 1305). In 1806, the process 1800 selects an initial value of the adjustment rate in a similar manner to that previously described (see, e.g., FIG. 13A, 1306).

Via linking reference “A,” the process 1800 can proceed to FIG. 18B. At 1808, the process 1800 performs an iterative sequence of m steps on value of the system adjustment rate (λ-actual). For the m steps, the iterative loop 1808 can include two parts: (i) an acquisition sequence of K base-periods based on measured torque (T) and speed (S); and (ii) a processing sequence for determining the amplitude and period for the oscillation of the torque and speed. The acquisition sequence 1810 can performed in N-step to fill T(i) and S(i) for i=1 to N_steps and includes steps 1812-1824, which can be the same or similar to those previously described in FIG. 11A at 1121-1129, or in FIG. 13B at 1309-2-1309-9.

Via linking reference “B,” the process 1800 can proceed to FIG. 18C. The Iterative process 1808 performs the aforementioned processing sequence 1830 that determines the total noise corresponding to the actual adjustment rate. More specifically, at 1832, the process 1800 performs a FFT on the records (T(n) and S(n)) stored at 1822, and obtains Tₐ(frₙ), Tₚₕ(frₙ), Sₐ(frₙ), Sₚₕ(frₙ) in a manner which can be the same or similar that described in FIG. 13 at 1310. At 1834, the process 1830 determines a frequency corresponding to the maximum amplitude for torque versus Frequency (i.e., “Fr-Torque”), which can be performed in the same or similar manner to that previously described herein (see, e.g., FIG. 11B, 1134). It also defines AT as the corresponding torque amplitude for that frequency Fr-Torque. At 1836, the process 1830 determines a frequency corresponding to the maximum amplitude for Speed vs. Frequency (Fr-Speed), which can be performed in the same or similar manner to that previously described herein (see, e.g., FIG. 11B, 1135). It also defines ΔS as the corresponding torque amplitude for that frequency Fr-Speed”). At 1838, the process 1800 determines the common base frequency FR-base based on Fr-Torque and Fr-Speed. At 1838, the process 1800 also determines the frequency threshold “Threshold” allowing the noise integration about this threshold. A possible definition:

FR-threshold=K-threshold FR-base (19)
wherein K-threshold equals at defined constant in relation to the noise bandwidth to reject (e.g., K-threshold=1.1)

At 1840, the process 1800 integrates the random noise above the threshold frequency FR-threshold. A potential definition for this noise integration is:

$$Random\_noise = \frac{1}{( {N}_{step} - K )} {\sum }_{i}^{N\_step} T ( i ) S ( i ) \qquad ( 20 )$$

Where K is the index corresponding to the frequency just larger than FR-threshold

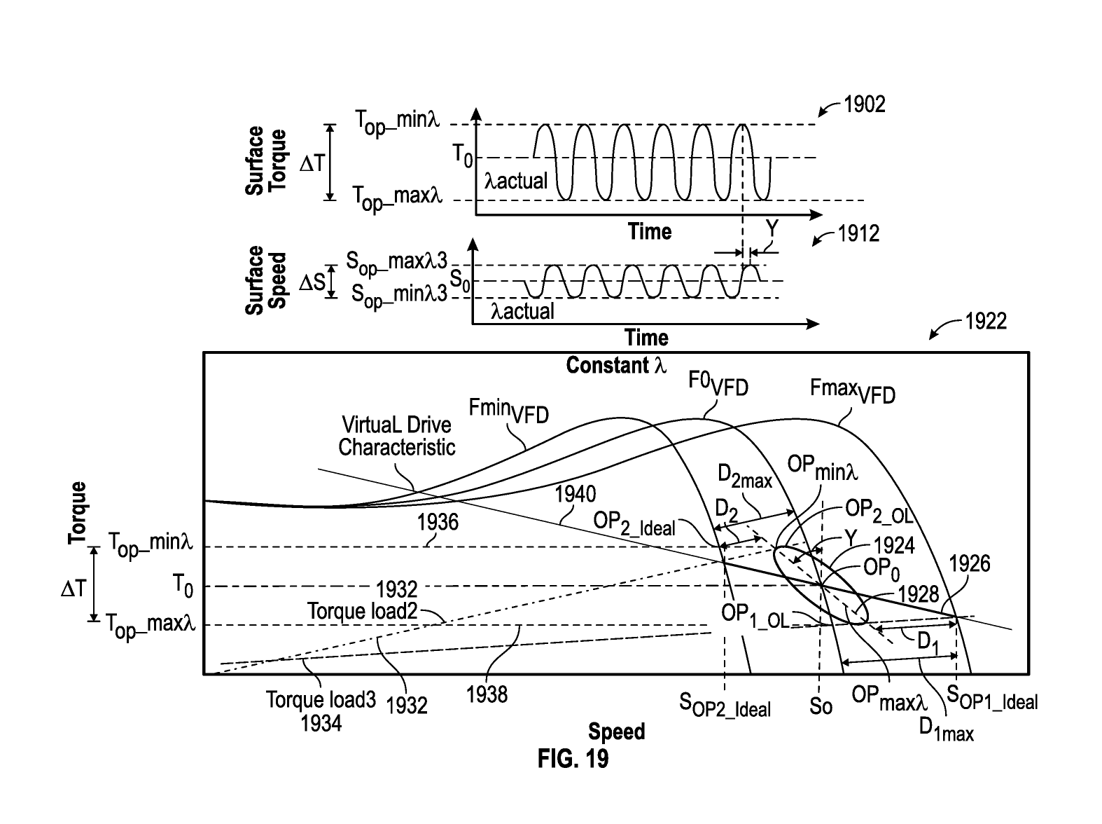

At 1842, the processing process 1830 determines the main axes of the operating ellipse 1924 by determining the points OP-mink and OP-maxλ. These points can be estimated as intersections between the ellipse axis 1928 tilted by the angle γ (which is the phase difference between Tph(j) and Sph(j) for j corresponding to the closet frequency to “FR-base”) and the line 1936 and 1938 corresponding to the maximum and minimum torques during the oscillation cycle. Such process is illustrated in FIG. 19 for the usage of formula 17 and based on linear estimator of torque loads passing by the points OP-minλ and OP-maλ of the operating ellipse.

OP2_ideal and OP1_ideal can be obtained as intersections with the extrapolated linear load lines 1932 and 1934 and the virtual drive characteristic.” Furthermore, the points OP2_OL and OP1_OL represent an estimation of the torque oscillation when the rotary system operates in open loop. These points would be also on the linear extrapolations 1838 and 1836 of torque load, With the determination these points, the distance D2max, D2, D1max and D1 can be determined. Then the “Match_error” (as defined in formula 17 can be estimated. At 1846, the process 1830 determined the normalized matching error called “match_error_normalized.”

In 1848, the process sums the effect of match error normalized (also called “coherent noise”) and noise power (also called “random noise”) to estimate the overall noise generated on the rotary drilling system. In 1850, the process 1830 records the total error in the vector Total noise(K) and the actual “adjustment rate” in the vector A(k) in relation with the k index of the iterative loop.

At 1854, the process 1800 increments λ-actual. At 1856, the process 1800 determines whether λ-actual incremented is less than λ-end. If not, the iterative loop 1808 restarts, as indicated by linking reference “C.” If the k-actual is greater than or equal to k-end, then at 1858, the process 1800 can determines a value system adjustment rate that minimizes the total noise injected into control of the motor 137 in relation to the drive target 1926 along the “virtual drive characteristic” 1940. In implementations, the optimized value of the adjustment rate parameter can be determined by selecting the minimum in the vector “Total Noise(n)” which has been filled during the execution of the iterative loop on incremental value of the adjustment rate. The processes 1800 allows implementations consistent with the present disclosure to tune the operation of a top drive system (e.g., top drive system 115) such that an impedance of the drill string assembly (e.g., drill string 305 and bottom hole assembly 306 and the motor rotor inertia 1210) substantially matches an impedance of the drive system (e.g., motor 137 driven by VFD 309), which provides smooth operation of a drilling rig (e.g., drilling rig 102). The tuning of the process 1800 associated with the matching of impedance between the drive system and the rotary assembly may also be associated with the tuning of the virtual inertia of the motor rotor in view of minimizing the matching of the resonance of the rotary assembly and the downhole excitation of the rotation oscillation which may-be measured by the sensors 164. Further, the process 1800 allows adjustment rate to control the power provided to the motor to minimize the effects of coherent and random noises in the system.

In accordance with aspects of the present disclosure, several improvements may be performed to have the rotation of the drill string. In one prefer implementation, the improvement for the virtual drive characteristic is performed first, then the improvement for the virtual inertia, and finally the improvement for the adjustment rate. The drilling process may also affect these improvements. The key control parameter external to these improvements is the weight-on-bit.

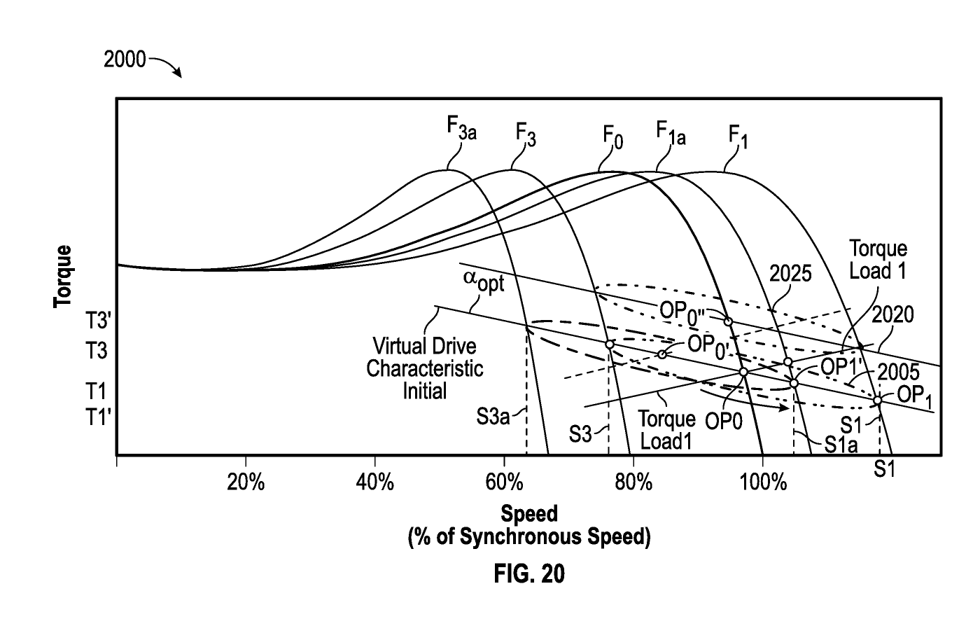

FIG. 20 shows a graph illustrating an example of a system response, according to an implementation. More specifically the graph 2000 represents the response of the motor (e.g. 137) when operating in presence of rotational variation along the wellbore (e.g. stick and slip). Ellipse 2005 represents the torque/speed response of the motor around the nominal conditions in the event of variation of rotational-conditions (e.g., stick-and-slip). However, external parameters may influence the nominal conditions, such as change in weight-on-bit, bit wear, rock strength.

With increased weight-on-bit, the torque typically increases. As effect of the virtual drive characteristic, the rotational speed reduces. When the rotation oscillation generated along the wellbore stays similar, the response of a motor may shift from the ellipse 2005 to the ellipse 2010. This shift includes a reduction of speed from a range of S1 and S3 to range of S1a and S3a, which may affect the rate of penetration of a drill bit. Accordingly, a controller implementing the systems and methods disclosed herein (e.g., controller 139) may force the drive system (e.g., motor 137 driven by VFD 309) to provide more power. This may be achieved by modifying virtual drive characteristic 2015 to virtual drive characteristic 2020 for increased power, for example The controller can perform this modification of the virtual drive characteristic 2015 by keeping a slope (λₒₚₜ) of the virtual drive characteristic 2015 at constant value and shifting it to the upper right-hand corner of the graph 2000. As a result of the modified the virtual drive characteristic 2020, the motor response would move from the ellipse 2010 to purple ellipse 2025, which would bring the output speed to the similar range (i.e., ranging from S1 and S3) as ellipse 2005; however the corresponding output torque would be higher for ellipse 1925. It should be noted that the reverse situation may exist if the drilling process applies lower weight-on-bit on bit. Then the resultant torque would be lower. Then the virtual characteristic line 2005 would be modified to shift towards the lower left corner to reduce the power.

After modifying the virtual drive characteristic 2005, the controller may re-optimize the parameters of the virtual drive characteristic, the virtual inertial of the motor, and the adjustment rate, as described previously herein with regard to FIGS. 4, 11A-11C, 13A-13D, and 18A-18C. It will be understood that the controller can re-optimize these parameters at any time during drilling operations to account for varying conditions (e.g., friction). In some implementations, the optimization of the three parameters may be repeatedly performed based on a predefined schedule. In other implementations, the optimization cycles can be performed at a substantially constant cycle.

In some implementation, the optimization of the virtual drive characteristic slope (α), the virtual inertia (βv) and the adjustment rate (λ) may be performed based on the down-hole measurement obtained by the sensor 164 and transmitted to surface via the down-hole communication system 313C. With fast down-hole communication such as based on cable or on wired-drill-pipe, the process to optimize these 3 parameters can be performed as described in previous section (and corresponding to FIGS. 11, 13 and 18). When slow down-hole communication such as based on MWD mud-pulse or E-mag telemetry, the data of the down-hole sensor 164 may have to be averaged over time (in the range of 15 sec or more). The optimization processing must also be adapted to delay due to the telemetry and data management within the controller 126 and 162. In such application, the down-hole data may only be used to confirm the proper selection of these 3 parameters using the processing described previously and using surface data (from sensor 135).

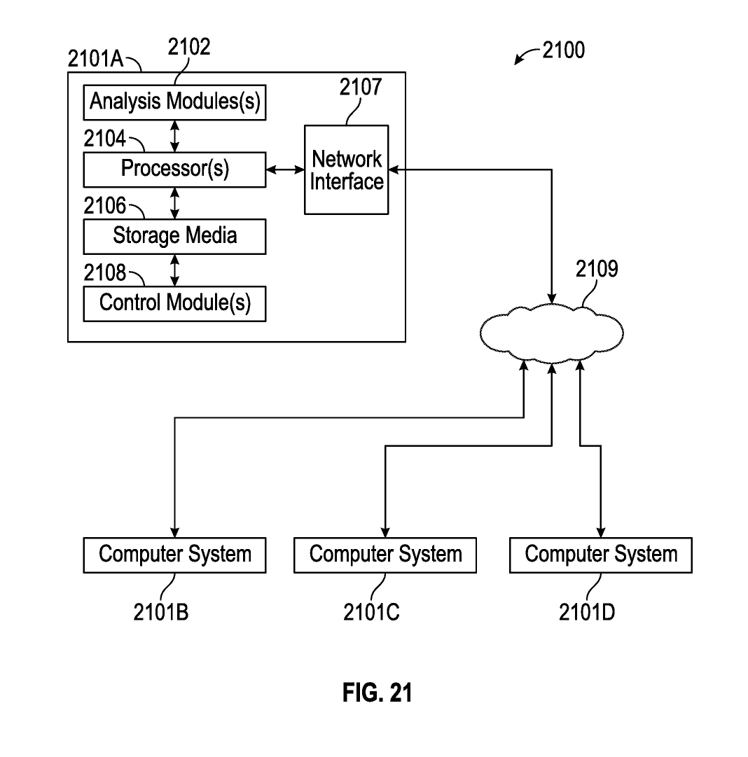

In some implementations, the methods of the present disclosure may be executed by a computing system. FIG. 21 illustrates an example of such a computing system 2100, in accordance with some implementations. The computing system 2100 may include a computer or computer system 2101A, which may be an individual computer system 2101A or an arrangement of distributed computer systems. The computer system 2101A includes one or more analysis modules 2102 that are configured to perform various tasks according to some implementations, such as one or more methods disclosed herein. To perform these various tasks, the analysis module 2102 executes independently, or in coordination with, one or more processors 2104, which is (or are) connected to one or more storage media 2106. The processor(s) 2104 is (or are) also connected to a network interface 2107 to allow the computer system 2101A to communicate over a data network 2109 with one or more additional computer systems and/or computing systems, such as 2101B, 2101C, and/or 2101D (note that computer systems 2101B, 2101C and/or 2101D may or may not share the same architecture as computer system 2101A, and may be located in different physical locations, e.g., computer systems 2101A and 2101B may be located in a processing facility, while in communication with one or more computer systems such as 2101C and/or 2101D that are located in one or more data centers, and/or located in varying countries on different continents).

A processor 2104 may include a microprocessor, microcontroller, processor module or subsystem, programmable integrated circuit, programmable gate array, or another control or computing device.

The storage media 2106 may be implemented as one or more computer-readable or machine-readable storage media. Note that while in the example implementation of FIG. 21 storage media 2106 is depicted as within computer system 2101A, in some implementations, storage media 2106 may be distributed within and/or across multiple internal and/or external enclosures of computing system 2101A and/or additional computing systems. Storage media 2106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY® disks, or other types of optical storage, or other types of storage devices. Note that the instructions discussed above may be provided on one computer-readable or machine-readable storage medium, or alternatively, may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some implementations, the computing system 2100 contains one or more control modules 2108 (e.g., controller 139). The control module 2108 may be used to perform at least a portion of one or more implementations of the methods disclosed herein above (e.g., processes 400, 1100, 1300, and 1800).

It should be appreciated that computing system 2100 is only one example of a computing system, and that computing system 2100 may have more or fewer components than shown, may combine additional components not depicted in the example implementation of FIG. 21, and/or computing system 2100 may have a different configuration or arrangement of the components depicted in FIG. 21. The various components shown in FIG. 21 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. Moreover, the order in which the elements of the methods described herein are illustrated and described may be re-arranged, and/or two or more elements may occur simultaneously. The implementations were chosen and described in order to best explain the principals of the invention and its practical applications, to thereby enable others skilled in the art to best utilize the invention and various implementations with various modifications as are suited to the particular use contemplated. Additional information supporting the disclosure is contained in the appendix attached hereto.

What is claimed is:

1. A system comprising:
An AC induction motor mechanically coupled to a rotary drilling system and configured to drive the rotary drilling system;
an electronic invertor to generate the supplied power for the induction motor; and
a control system configured to drive the operation of the invertor to impose a virtual drive characteristic relating torque output of the motor with speed of the motor.

2. The system of claim 1, wherein the virtual drive characteristic is a linear relation between torques of the motor versus speeds of the motor, while passing by a selected averaged operating point.

3. The system of claim 1, wherein the controller is configured to select a first frequency to drive the electronic inverter so that the AC induction motor response matches the virtual drive characteristics within a range of frequencies.

4. The system of claim 3, wherein generating the supplied power comprises:
determining the one or more rotational conditions of the rotary drilling system by measuring first rotational parameters of the rotary drilling system;
determining a first operating point of the rotary drilling system based on the first rotational parameters of the rotary drilling system, the first operating point comprising a first target speed of the rotary drilling system corresponding to the virtual drive characteristic;
determining, based on the first operating point of the rotary drilling system, the first frequency of the range of frequencies corresponding to the first target speed; and
generating the supplied power at the first frequency of the range of frequencies.

5. The system of claim 4, wherein generating the supply power further comprises:
measuring second rotational parameters of the rotary drilling system;
determining a second operating point of the rotary drilling system based on the second rotational parameters of the rotary drilling system, the second operating point comprising a second target speed of the rotary drilling system corresponding to the virtual drive characteristic;
determining, based on the second operating point of the rotary drilling system, a second frequency of the range of frequencies corresponding to the second target speed; and
generating the supplied power at the second frequency of the range of frequencies.

6. The system of claim 5, wherein:
the first rotational parameters comprise a first torque load;
the second rotational parameters comprise a second torque load different from the first torque load;
determining the first operating point of the rotary drilling system comprises determining the first target speed corresponding to the first torque load based on the association between torque and speed defined by the virtual drive characteristic; and
determining the second operating point of the rotary drilling system comprises determining the second target speed corresponding to the second torque load based on the association between torque and speed defined by the virtual drive characteristic.

7. The system of claim 1, wherein the control system is further configured to modify the virtual drive characteristic by:
operating the rotary drilling system during a plurality of successive time periods using a plurality of slopes of the virtual drive characteristic;
determining, for the different slopes of the virtual drive characteristic, a respective plurality of rotational parameters of the rotary drilling system, the plurality of rotational parameters including torques and speeds measured at the rotary drilling system over the range of frequencies for the supplied power;
determining a first rotational parameter selected as an maximum from the plurality of rotational parameters that provides the optimum combination of the torques and speeds measured at the rotary drilling system; and
selecting a first value of the slope of the virtual drive characteristic corresponding to the first rotational parameter for optimum coupling between the motor driven by supplied power at frequency matching the virtual characteristic drive and the rotary drilling assembly

8. The system of claim 1, wherein the controller is further configured to determine a virtual motor inertia of the motor that substantially minimizes the effect of resonance in the rotary drilling system.

9. The system of claim 8, wherein:
the controller is configured to control the supplied power in accordance to the virtual characteristic drive and the virtual motor inertia; and
the AC induction motor rotates the rotary assembly,
wherein rotational conditions in a well-bore minimize excitation of the resonance of the rotary assembly is corrected by the virtual motor inertia.

10. The system of claim 8, wherein:
determining the virtual motor inertia comprises iteratively determining, for a range of virtual motor inertias, a plurality of rotational parameters of the rotary drilling system, the plurality of rotational parameters including torques and accelerations measured at the rotary drilling system over the range of frequencies; and
determining rotational parameters selected from the plurality of rotational parameters that maximize or minimize a combination of the torques and speeds measured at the rotary drilling system over the range of frequencies.

11. The system of claim 1, wherein the controller is further configured to determine an adjustment rate of the supplied power that minimizes total noise in the rotary drilling system, where in the total noise is a combination of:
coherent noise generated by the lagging response for a setting of torque versus speed in relation to the virtual drive characteristic,
random noise generated by behavior of the control system, the electronic inverter and/or the AC induction motor when the system is operated in non-steady conditions.

12. The system of claim 11, wherein determining the adjustment rate comprises:
iteratively determining, for a range of adjustment rate, a plurality of rotational parameters of the rotary drilling system, the plurality of rotational parameters including torques and rotation speed and accelerations measured at the rotary drilling system over the range of frequencies; and
determining rotational parameters selected from the plurality of rotational parameters that minimize the total noise measured at the rotary drilling system over the range of frequencies.

13. A method for controlling a rotary drilling system, the method comprising:
obtaining one or more rotational conditions of the rotary drilling system driven by a motor supplied by an inverter;
determining a first desired operating point of the motor, the first desired operating point comprising a torque and speed at an intersection of a driven torque load and a virtual drive characteristic;
selecting a first frequency of the inverter, the first frequency allowing a characteristic of the motor to pass by the first desired operating point; and
generating a supply power for the motor at the first frequency.

14. The method of claim 13, wherein generating the supply power comprises selecting the first frequency from a range of frequencies so that the motor characteristic for that first frequency corresponds to the intersection of the driven torque load and the virtual drive characteristic as a relation of rotational torque versus speed with a range of speeds of the motor and a respective range of torques provided by the motor.

15. The method of claim 14, wherein generating the supply power comprises:
determining the one or more rotational conditions of the rotary drilling system by measuring first rotational parameters of the rotary drilling system;
determining the first desired operating point of the rotary drilling system based on the first rotational parameters of the rotary drilling system, the first operating point being at the intersection of a driven torque load and the virtual drive characteristic comprising a first target speed of the rotary drilling system corresponding to a torque load required by the rotary drilling system;
determining, based on the first operating point of the rotary drilling system, the first frequency of the range of frequencies corresponding to the first target speed based on a motor response characteristic; and
generating the supply power at the first frequency of the range of frequencies.

16. The method of claim 15, wherein generating the supply power further comprises:
measuring second rotational parameters of the rotary drilling system;
determining a second desired operating point of the rotary drilling system based on the second rotational parameters of the rotary drilling system, the second desired operating point being at an intersection of the driven torque load and the virtual drive characteristic comprising a second target speed of the rotary drilling system corresponding to a torque load required for the rotation of the rotary drilling system.
determining, based on the second operating point of the rotary drilling system, a second frequency of the range of frequencies corresponding to the second target speed in relation with the motor characteristics; and
generating the supply power at the second frequency of the range of frequencies.

17. The method of claim 16, wherein:
the first rotational parameters comprise a first torque load;
the second rotational parameters comprise a second torque load different from the first torque load;
determining the first desired operating point of the rotary drilling system comprises determining the first target speed corresponding to the first torque load based on the first intersection of the torque load and the virtual drive characteristic which are the required correspondence between torque and speed at the motor; and
determining the second desired operating point of the rotary drilling system comprises determining the second intersection of the torque load and the virtual drive characteristic which are required correspondence between torque and speed or the motor.

18. The method of claim 13, further comprising modifying the virtual drive characteristic by:
operating the rotary drilling system during a plurality of successive time periods using a plurality of slopes of the virtual drive characteristic;
determining, for the different slopes of the virtual drive characteristic, a respective plurality of rotational parameters of the rotary drilling system, the plurality of rotational parameters including torques and speeds measured at the rotary drilling system;
determining a first rotational parameter selected from the plurality of rotational parameters that maximizes or minimizes a combination of the variations of torques and speeds measured at the rotary drilling system; and
selecting a first value of the slope of the virtual drive characteristic corresponding to the first rotational parameter.

19. The method of claim 13, further comprising determining a virtual motor inertia of the motor that substantially modifies the frequency of resonance of a rotary drilling assembly.

20. The method of claim 19, further comprising minimizing effects of rotary oscillation by minimizing a coupling of resonance of the rotary drilling system on a torsional excitation due to variation of a rotary drilling condition along a well-bore.

21. The method of claim 20, wherein determining the virtual motor inertia comprises iteratively determining, for a range of virtual motor inertias, a plurality of rotational parameters of the rotary drilling system, the plurality of rotational parameters including torques, speed and accelerations measured at the rotary drilling system; and
determining rotational parameters selected from the plurality of rotational parameters that maximize or minimize a combination of the variation of torques and speeds from the measurements at the rotary drilling system over the range of frequencies.

22. The method claim 13 further comprising determining an adjustment rate of the supply power that minimizes total noise in the rotary drilling system.

23. The method claim 13, wherein determining the adjustment rate comprises:
iteratively determining, for a range of adjustment rates, a plurality of rotational parameters of the rotary drilling system, the plurality of rotational parameters including torques, speed and accelerations measured at the rotary drilling system; and
determining rotational parameters selected from the plurality of rotational parameters that maximize or minimize a combination of the variations of torques and speeds from the measurements at the rotary drilling system over the range of frequencies.

24. The method of claim 13, further comprising optimizing a slope of the virtual drive characteristic based on a motor rotor virtual inertia based on sensor data obtained from a bore-hole and transmitted to a surface controller via down-hole telemetry.
